(19) United States
(12) Patent Application Publication
(10) Pub. No.: US 2025/0205687 A1
(43) Pub. Date: Jun. 26, 2025

(54) TUNABLE SUPPORTED CATALYSTS DERIVED FROM METAL ORGANIC FRAMEWORKS

(71) Applicant: Khalifa University of Science and Technology, Abu Dhabi (AE)

(72) Inventors: Kyriaki POLYCHRONOPOULOU, Abu Dhabi (AE); Eswara Vara Prasadarao KOMARALA, Abu Dhabi (AE); Aasif Asharafbhai DABBAWALA, Abu Dhabi (AE)

(21) Appl. No.: 18/849,057

(22) PCT Filed: Apr. 5, 2023
(86) PCT No.: PCT/IB2023/053489

§ 371 Date: Sep. 20, 2024

Related U.S. Application Data
(60) Provisional application No. 63/336,631, filed on Apr. 29, 2022.

(51) Int. Cl. B01J 23/10; B01J 23/755; B01J 35/45; B01J 35/50; B01J 35/61; B01J 35/63; B01J 35/64; B01J 37/08; B01J 37/34

(52) U.S. Cl. CPC B01J 23/10; B01J 23/755; B01J 35/45; B01J 35/50; B01J 35/612; B01J 35/613; B01J 35/633; B01J 35/647; B01J 37/08; B01J 37/343

(57) ABSTRACT

A catalyst includes a lanthanum support including one or more of lanthanum oxycarbonate, lanthanum oxide, and lanthanum hydroxide, and nanoparticles including one or more of a transition metal and a transition metal oxide, wherein the nanoparticles are in contact with the lanthanum support sufficient for strong metal-support interaction (SMSI) and the nanoparticles are lanthanide-free and actinide-free.

### CROSS-REFERENCE TO RELATED APPLICATION

This application claims benefit of U.S. Provisional Application No. 63/336,631 filed on Apr. 29, 2022. U.S. Provisional Application No. 63/336,631 is incorporated herein by reference. A claim of priority is made.

### BACKGROUND

Dry reforming of methane (DRM) is an endothermic reaction that produces synthesis gas with an H₂/CO ratio of 1 (CH₄+CO₂+2 CO+2H₂; ΔH° (298 K)=+247.3 kJ mol⁻¹). The produced syngas is used to produce high value-added chemicals and fuel. However, this process has not been industrialized yet due to the absence of a robust catalyst that can resist sintering and carbon formation. These phenomena occur due to the high operational temperature of the reaction and the simultaneous side reactions (methane decomposition and CO disproportionation reaction), respectively. Further, CO₂ reduction reactions, N₂ reduction reactions, and CO₂ adsorption require a robust catalyst for resisting carbon formation. Therefore, it is vital to tailor a coke-resistant catalyst with exceptional stability in conversion rates for catalytic reactions and adsorption applications.

### SUMMARY

According to one aspect, a catalyst includes a lanthanum support including one or more of lanthanum oxycarbonate, lanthanum oxide, and lanthanum hydroxide, and nanoparticles including one or more of a transition metal and a transition metal oxide, wherein the nanoparticles are in contact with the lanthanum support sufficient for strong metal-support interaction (SMSI) and the nanoparticles are lanthanide-free and actinide-free.

According to another aspect, a method of processing a feed stock includes contacting the feed stock with a catalyst, sufficient to generate a reaction product. The catalyst includes a lanthanum support including one or more of lanthanum oxycarbonate, lanthanum oxide, and lanthanum hydroxide, and nanoparticles including one or more of a transition metal and a transition metal oxide, wherein the nanoparticles are in contact with the lanthanum support sufficient for strong metal-support interaction (SMSI) and are lanthanide and actinide-free.

According to another aspect, a method of making a catalyst includes providing a first solution including sonication of a first metal organic framework (MOF), providing a second solution including sonication of a second MOF, and contacting the first solution and the second solution sufficient to form a third solution. The method of making the catalyst further includes sonicating the third solution sufficient to interact the first MOF with the second MOF and form a coalesced MOF, separating and drying the coalesced MOF, and heating the coalesced MOF at a temperature setpoint sufficient to obtain the catalyst.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 illustrates a method 100 of processing a feed stock, according to some embodiments.

FIG. 2 illustrates a method 200 of making a catalyst, according to some embodiments.

FIG. 3A illustrates XRD patterns of as-synthesized Ni-BDC and La-BDC metal organic frameworks (MOFs), with inset images illustrating the respective powders, according to some embodiments.

FIG. 3B illustrates XRD patterns of a physical mixture and sonicated samples of Ni-BDC and La-BDC MOFs in a 1:1 weight ratio, with the inset image illustrating a shift in the sonicated sample toward lower angle shift, indicating interaction between the MOFs, according to some embodiments.

FIG. 4 illustrates XRD patterns of Ni-BDC, La-BDC MOFs, and the coalesced Ni-&La-BDC MOFs calcined at 250° C. with the inset image illustrating lower-angle shift in the coalesced sample and the sample being in MOF phase, according to some embodiments.

FIG. 5A illustrates XRD patterns of Ni-BDC and coalesced Ni-&La-BDC MOFs calcined at different temperatures viz., 400, 600, and 800° C. for 2 hours, according to some embodiments.

FIG. 5B illustrates XRD patterns of Ni-BDC and coalesced Ni-&La-BDC MOFs calcined at different temperatures viz., 400, 600, and 800° C. after reduction at 800° C. for 2 hours, according to some embodiments.

FIG. 6A illustrates DSC-TGA profiles of Ni-BDC MOF in oxygen atmosphere, according to some embodiments.

FIG. 6B illustrates DSC-TGA profiles of La-BDC MOF in oxygen atmosphere, according to some embodiments.

FIG. 6C illustrates DSC-TGA profiles of a Ni-BDC MOF/La-BDC MOF physical mixture in oxygen atmosphere in a 1:1 weight ratio, according to some embodiments.

FIG. 6D illustrates DSC-TGA profiles of sonicated Ni-BDC MOF/La-BDC MOF in oxygen atmosphere in a 1:1 weight ratio, according to some embodiments.

FIG. 7A illustrates an XRD pattern of as-synthesized Ni—La-500-WI (wetness impregnation) catalyst, with the inset illustrating the powder sample image, according to some embodiments.

FIG. 7B illustrates an SEM image of as-synthesized Ni—La-500-WI catalyst, according to some embodiments.

FIG. 7C illustrates elemental mapping of Ni in the as-synthesized Ni—La-500-WI catalyst, according to some embodiments.

FIG. 7D illustrates elemental mapping of La in the as-synthesized Ni—La-500-WI catalyst, according to some embodiments.

FIG. 8A illustrates an XRD of the as-synthesized Ni—La-500 catalyst, with the inset illustrating the powder sample image, according to some embodiments.

FIG. 8B illustrates a high-resolution TEM image of the as-synthesized Ni—La-500 catalyst, according to some embodiments.

FIG. 8C illustrates a high-resolution TEM image of the as-synthesized Ni—La-500 catalyst, according to some embodiments.

FIG. 8D illustrates an SEM image of as-synthesized Ni—La-500 catalyst, according to some embodiments.

FIG. 8E illustrates elemental mapping of Ni in the as-synthesized Ni—La-500 catalyst, according to some embodiments.

FIG. 8F illustrates elemental mapping of La in the as-synthesized Ni—La-500 catalyst, according to some embodiments.

FIG. 9A illustrates SEM-EDS spectra and the corresponding elemental analysis of Ni—La-500, according to some embodiments.

FIG. 9B illustrates SEM-EDS spectra and the corresponding elemental analysis of Ni—La-500-PM, according to some embodiments.

FIG. 10A illustrates an XRD pattern of as-synthesized Ni—La-500-PM catalyst, with the inset illustrating the powder sample image, according to some embodiments.

FIG. 10B illustrates an SEM image of as-synthesized Ni—La-500-PM catalyst, according to some embodiments.

FIG. 10C illustrates elemental mapping of Ni in the as-synthesized Ni—La-500-PM catalyst, according to some embodiments.

FIG. 10D illustrates elemental mapping of La in the as-synthesized Ni—La-500-PM catalyst, according to some embodiments.

FIG. 11 illustrates XPS survey spectra of as-synthesized Ni—La-500 and Ni—La-500 PM catalysts, according to some embodiments.

FIG. 12A illustrates XPS spectra of as-synthesized Ni—La-500 and Ni—La-500 PM catalysts including Ni2p and La3d spectra, according to some embodiments.

FIG. 12B illustrates XPS spectra of as-synthesized Ni—La-500 and Ni—La-500 PM catalysts including Ni3p spectra, according to some embodiments.

FIG. 12C illustrates XPS spectra of as-synthesized Ni—La-500 and Ni—La-500 PM catalysts including C1s spectra, according to some embodiments.

FIG. 12D illustrates XPS spectra of as-synthesized Ni—La-500 and Ni—La-500 PM catalysts including O1s spectra, according to some embodiments.

FIG. 13A illustrates a powder image of Ni—La-250 where the synthesized catalyst is calcined at 250° C., according to some embodiments.

FIG. 13B illustrates a powder image of Ni—La-400 where the synthesized catalyst is calcined at 400° C., according to some embodiments.

FIG. 13C illustrates a powder image of Ni—La-600 where the synthesized catalyst is calcined at 600° C., according to some embodiments.

FIG. 13D illustrates a powder image of Ni—La-800 where the synthesized catalyst is calcined at 800° C., according to some embodiments.

FIG. 13E illustrates XRD patterns of synthesized Ni—La-250, Ni—La-400, Ni—La, 600, and Ni—La-800, according to some embodiments.

FIG. 13F illustrates XRD patterns of reduced Ni—La-400, Ni—La-600, and Ni—La-800, according to some embodiments.

FIG. 14A illustrates an SEM image of as-synthesized Ni—La-400, according to some embodiments.

FIG. 14B illustrates an SEM image of as-synthesized Ni—La-600, according to some embodiments.

FIG. 14C illustrates an SEM image of as-synthesized Ni—La-800, according to some embodiments.

FIG. 14D illustrates an SEM image of reduced Ni—La-400, according to some embodiments.

FIG. 14E illustrates an SEM image of reduced Ni—La-600, according to some embodiments.

FIG. 14F illustrates an SEM image of reduced Ni—La-800, according to some embodiments.

FIG. 15 illustrates SEM images of as-synthesized coalesced Ni-&La-BDC MOFs calcined at different temperatures viz., 400, 600, 800° C. and reduced 800° C. sample, according to some embodiments.

FIG. 16A illustrates a TEM analysis of the as-synthesized Ni—La-800 catalyst, showing the formation of 100-200 nm particles of the catalyst, according to some embodiments.

FIG. 16B illustrates a TEM analysis of the as-synthesized Ni—La-800 catalyst, showing the formation of 100-200 nm particles of the catalyst, according to some embodiments.

FIG. 16C illustrates a TEM analysis of the as-synthesized Ni—La-800 catalyst, showing an embedded NiO nanoparticle (20 nm in size) in the La₂O₃ support, confirming the strong metal-support interactions (SMSI), according to some embodiments.

FIG. 16D illustrates a TEM analysis of the as-synthesized Ni—La-800 catalyst, showing the formation of stacking faults in the La₂O₃ phase, according to some embodiments.

FIG. 16E illustrates the STEM image used for the EDS analysis at three different points to know the co-existence of Ni and La phases, according to some embodiments.

FIG. 16F illustrates the corresponding EDS spectra with P1 showing the pure Ni phase, according to some embodiments.

FIG. 16G illustrates the corresponding EDS spectra with P2 showing the Ni and La phases, according to some embodiments.

FIG. 16H illustrates the corresponding EDS spectra with P3 showing the Ni and La phases, according to some embodiments.

FIG. 17A illustrates an N₂ adsorption-desorption isotherm (inset shows the pore size distribution) of as-synthesized Ni—La-500 and Ni—La-500 PM catalysts, according to some embodiments.

FIG. 17B illustrates H₂-Temperature programed reduction (H₂-TPR) of as-synthesized Ni—La-500 and Ni—La-500 PM catalysts, according to some embodiments.

FIG. 17C illustrates CO₂-Temperature programed desorption (CO₂-TPD) of as-synthesized Ni—La-500 and Ni—La-500 PM catalysts, according to some embodiments.

FIG. 17D illustrates H₂-Temperature programed desorption (H₂-TPD) profiles of as-synthesized Ni—La-500 and Ni—La-500 PM catalysts, according to some embodiments.

FIG. 18 illustrates CO₂-Temperature programmed desorption (TPD) profiles of Ni-BDC MOF and coalesced Ni-&La-BDC MOFs calcined at 400, 600, and 800° C., according to some embodiments.

FIG. 19A illustrates N₂ adsorption-desorption isotherms of Ni—La-400, Ni—La-600, Ni—La-800 and Ni—La-500-WI (wetness impregnation) catalysts, according to some embodiments.

FIG. 19B illustrates pore size distribution profiles of Ni—La-400, Ni—La-600, Ni—La-800 and Ni—La-500-WI (wetness impregnation) catalysts, according to some embodiments.

FIG. 20A illustrates N₂ adsorption-desorption hysteresis of Ni-BDC MOF and coalesced Ni-&La-BDC MOFs calcined at 400, 600, and 800° C., according to some embodiments.

FIG. 20B illustrates the corresponding pore volume-size distribution profiles of Ni-BDC MOF and coalesced Ni-&La-BDC MOFs calcined at 400, 600, and 800° C., according to some embodiments.

FIG. 21 illustrates H₂-TPR profiles of Ni—La-400, Ni—La-600, Ni—La-800, and Ni—La-500-WI (wetness impregnation) catalysts, according to some embodiments.

FIG. 22 illustrates H₂-temperature programmed reduction (TPR) profiles of Ni-BDC MOF and coalesced Ni-&La-BDC MOFs calcined at 400, 600, and 800° C. in 5% H₂ with a heating rate of 10° C./min, according to some embodiments.

FIG. 23A illustrates XRD patterns of reduced Ni—La-500, Ni—La-500 PM, and Ni—La-500 WI catalysts, according to some embodiments.

FIG. 23B illustrates an SEM image of reduced Ni—La-500, according to some embodiments.

FIG. 23C illustrates an SEM image of reduced Ni—La-500-PM, according to some embodiments.

FIG. 23D illustrates an SEM image of reduced Ni—La-500-WI, according to some embodiments.

FIG. 24A illustrates TEM-HAADF analysis along with RGB elemental mapping of the Ni—La-500 reduced catalyst, according to some embodiments.

FIG. 24B illustrates TEM-HAADF analysis along with RGB elemental mapping of the Ni—La-500 PM reduced catalyst, according to some embodiments.

FIG. 24C illustrates TEM-HAADF analysis along with RGB elemental mapping of the Ni—La-500 WI reduced catalyst, according to some embodiments.

FIG. 25A illustrates normalized XANES Ni K-edge spectra of reduced Ni—La-500 catalyst, according to some embodiments.

FIG. 25B illustrates normalized XANES La L3-edge spectra of reduced Ni—La-500 catalyst, according to some embodiments.

FIG. 25C illustrates normalized XANES second derivative La L3-edge spectra of reduced Ni—La-500 catalyst, according to some embodiments.

FIG. 25D illustrates normalized K³-weighed EXAFS signals at the Ni K-edge of reduced Ni—La-500 catalyst, according to some embodiments.

FIG. 25E illustrates the corresponding Fourier transform with Ni Metal, NiO, and reduced Ni—La-500 catalyst, according to some embodiments.

FIG. 26 illustrates CO₂-Adsorption profiles of coalesced Ni-&La-BDC MOFs calcined at 400, 600, and 800° C. at room temperature and up to 1 bar pressure, according to some embodiments.

FIG. 27A illustrates DRM (dry reforming of methane) activity of an MOF derived Ni—La-500 catalyst showing CH₄ and CO₂ conversion rates, according to some embodiments.

FIG. 27B illustrates DRM activity of MOF derived Ni—La-500 catalyst showing H₂:CO product ratio, according to some embodiments.

FIG. 28A illustrates a comparison of DRM activity of Ni—La-400, Ni—La-600, and Ni—La-800 catalysts based on CH₄ conversion, according to some embodiments.

FIG. 28B illustrates a comparison of DRM activity of Ni—La-400, Ni—La-600, and Ni—La-800 catalysts based on CO₂ conversion, according to some embodiments.

FIG. 28C illustrates a comparison of DRM activity of Ni—La-400, Ni—La-600, and Ni—La-800 catalysts based on H₂:CO product ratio, according to some embodiments.

FIG. 29A illustrates an SEM image of as-synthesized Ni—La-600 catalyst, according to some embodiments.

FIG. 29B illustrates elemental mapping of Ni in the Ni—La-600 catalyst, according to some embodiments.

FIG. 29C illustrates elemental mapping of La in the Ni—La-600 catalyst, according to some embodiments.

FIG. 29D illustrates an SEM image of a reduced Ni—La-600 catalyst, according to some embodiments.

FIG. 29E illustrates elemental mapping of Ni in the reduced Ni—La-600 catalyst, according to some embodiments.

FIG. 29F illustrates elemental mapping of La in the reduced Ni—La-600 catalyst, according to some embodiments.

FIG. 30A illustrates TEM analysis of reduced Ni—La-800 catalyst, showing the distributed and exsolved Ni nanoparticles on La₂O₃ support, according to some embodiments.

FIG. 30B illustrates TEM analysis of reduced Ni—La-800 catalyst, showing the distributed and exsolved Ni nanoparticles on La₂O₃ support, according to some embodiments.

FIG. 30C illustrates TEM analysis of reduced Ni—La-800 catalyst, showing the strongly anchored 10-20 nm sized Ni nanoparticles on the support, according to some embodiments.

FIG. 30D illustrates TEM analysis of reduced Ni—La-800 catalyst, showing the strongly anchored 10-20 nm sized Ni nanoparticles on the support, according to some embodiments.

FIG. 30E illustrates an STEM image of reduced Ni—La-800 catalyst used for the EDS analysis at three different points to see the distribution of Ni nanoparticles on La₂O₃ after reduction, according to some embodiments.

FIG. 30F illustrates the corresponding EDS spectrum with P1 showing the pure La₂O₃ phase, according to some embodiments.

FIG. 30G illustrates the corresponding EDS spectrum with P2 showing both Ni and La phases, according to some embodiments.

FIG. 30H illustrates the corresponding EDS spectrum with P3 showing the pure Ni phase, according to some embodiments.

FIG. 31A illustrates an XRD pattern of Ni—La-500 after DRM reaction, according to some embodiments.

FIG. 31B illustrates a low-magnification TEM image of Ni—La-500 after DRM reaction, according to some embodiments.

FIG. 31C illustrates an SEM image of Ni—La-500 catalyst after DRM reaction, according to some embodiments.

FIG. 31D illustrates elemental mapping of Ni for Ni—La-500 catalyst after DRM reaction, according to some embodiments.

FIG. 31E illustrates elemental mapping of La for Ni—La-500 catalyst after DRM reaction, according to some embodiments.

FIG. 32A illustrates a TEM image of Ni—La-500 catalyst after DRM, showing no signs of carbon formation, according to some embodiments.

FIG. 32B illustrates a TEM image of Ni—La-500 catalyst after DRM, showing Ni nanoparticles embedded in to the support with strong SMSI, according to some embodiments.

FIG. 32C illustrates a TEM image of Ni—La-500 catalyst after DRM, showing Ni nanoparticles embedded in to the support with strong SMSI, according to some embodiments.

FIG. 32D illustrates a TEM image showing very slight carbon formed in the form of graphitic carbon surrounding the Ni nanoparticles, according to some embodiments.

FIG. 33A illustrates a comparison of DRM activity for CH₄ conversion with a Ni—La-500 catalyst with comparison 1 catalyst Ni—La-500-WI (wetness impregnation), comparison 2 catalyst (5 wt % Ni/CeLa-10Cu—O) and comparison 3 catalyst (industrial steam reforming of methane catalyst), according to some embodiments.

FIG. 33B illustrates a comparison of DRM activity for CO₂ conversion with a Ni—La-500 catalyst with comparison 1 catalyst Ni—La-500-WI (wetness impregnation), comparison 2 catalyst (5 wt % Ni/CeLa-10Cu—O) and comparison 3 catalyst (industrial steam reforming of methane catalyst), according to some embodiments.

FIG. 33C illustrates a comparison of DRM activity for H₂:CO product ratio with a Ni—La-500 catalyst with comparison 1 catalyst Ni—La-500-WI (wetness impregnation), comparison 2 catalyst (5 wt % Ni/CeLa-10Cu—O) and comparison 3 catalyst (industrial steam reforming of methane catalyst), according to some embodiments.

FIG. 34A illustrates an SEM image (before DRM activity or reduced) of Ni—La-500-WI, according to some embodiments.

FIG. 34B illustrates an SEM image (before DRM activity or reduced) of Ni—La-500-WI, according to some embodiments.

FIG. 34C illustrates an SEM image (after DRM activity) of Ni—La-500-WI, according to some embodiments.

FIG. 34D illustrates an SEM image (after DRM activity) of Ni—La-500-WI, according to some embodiments.

### DETAILED DESCRIPTION

### Definitions

As used herein, the term “adsorption” may refer to accumulation of one phase on another phase. Adsorption may refer to the accumulation of a gas, liquid, or solid on/to a surface. One example of an adsorption application is CO₂ adsorption.

As used herein, the term “calcine” refers to treatment of a substance, such as heating or thermal treatment of a solid. Calcining may be completed at various temperatures and pressures. For example, calcining may include utilizing inert gas, air, ammonia, and H₂S environments. Calcining may involve the decomposition of one or more substances. The calcining process may be completed using a furnace or reactor.

As used herein, the term “catalyst” may refer to a substance utilized for increasing the rate of a reaction. Catalysts can increase the rate of the reaction without being consumed. Catalysts may be utilized in chemical reactions and adsorption applications.

As used herein, the term “coalesced” may refer to two or more substances or structures that have come together to form one structure, group, or mass.

As used herein, the term “DRM” refers to dry reforming of methane.

As used herein, the term “GHSV” refers to gas hourly space velocity.

As used herein, the term “MOF” refers to metal organic framework. Metal organic frameworks are a coordination network with organic ligands and may be present in multiple dimensions.

As used herein, the term “RWGS” refers to reverse water gas shift reaction.

As used herein, the term “SMSI” refers to strong metal-support interactions. For example, the strong metal-support interactions may be a strong interaction observed between metal nanoparticles and supports.

As used herein, the term “sonicate” refers to applying energy and/or vibration to a solid, liquid, and/or gas. Sonication may refer to applying sound energy.

### Discussion

Embodiments of the present disclosure describe novel catalysts and approaches to improve conversions, improve the stability of conversion rates, and reducing coking in catalytic reactions. Current catalysts have poor stability of conversion rates and suffer from coking and sintering. The catalysts of the present disclosure exhibit tunable adsorption capabilities with reduced coking. The reduced coking of these catalysts expands the industrial applicability to various industrial reactions.

In one example, the catalysts of the present disclosure are derived from two or more metal organic framework (MOF) precursors which are coalesced by sonication and calcined. MOFs are a coordination network with organic ligands and may be present in multiple dimensions. Calcination may include various temperature and atmospheric conditions. These tuned catalysts have strong metal-support interactions (SMSI). The SMSI may be a strong interaction observed between metal nanoparticles and reducible supports. SMSI may provide highly dispersed nanoparticles on the support. SMSI may be formed from oxygen via the support. These SMSI assist in preventing coking and forming tunable structures and performances for the catalyst. For example, SMSI may improve the stability of conversion rates, species diffusion, and electron flow. In another example, the SMSI is shown by nanoparticles strongly embedded in a support, both before and after a reaction (such as DRM). The catalyst may include a metal phase and a support/carrier.

In one example, the MOF precursors may include metals, transition metals, noble metals, lanthanoids, and actinoids. For example, the MOF precursors may include a metal selected from scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, lanthanum, and cerium. In another example, the MOF precursors include an organic ligand. For example, the MOF precursors may include an organic ligand selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), and BPY (2,2′-bipyridine). The MOF precursors may include various topologies sufficient to form the catalyst. Examples of a topology based on various organic ligands is shown below, with spheres denoting metal ions and lines denoting the organic ligands.

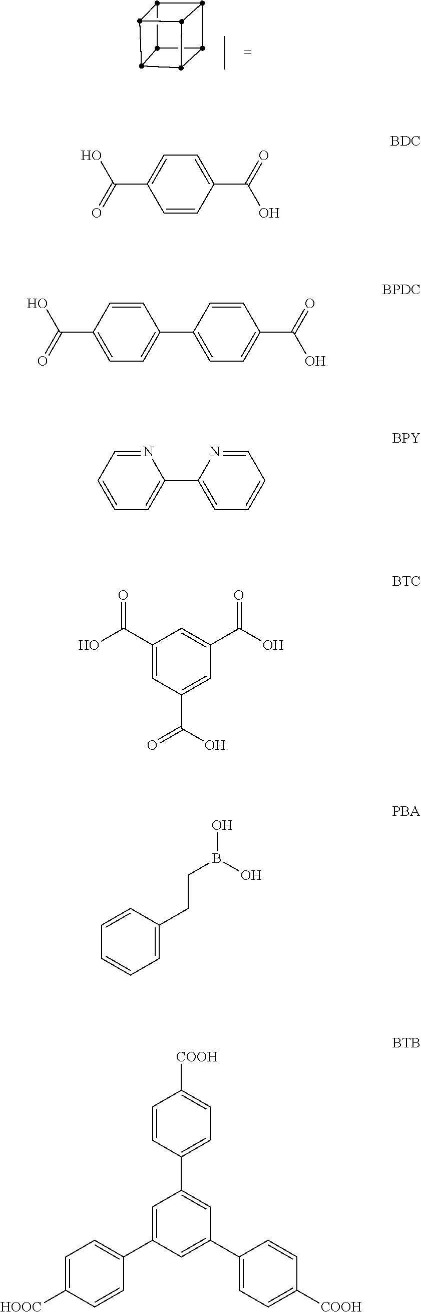

The catalyst may be formed by the simultaneous decomposition of two or more distinct MOF precursors to form individual phases with significant interactions. The catalysts can include a wide variety of metal/metal oxides and supports with different stoichiometry by varying the MOF precursor weight ratios. The two or more distinct MOF precursors may include a first MOF and a second MOF. For example, the first MOF and the second MOF may have a weight ratio ranging from about 1:4 to about 4:1. In another example, the first MOF and the second MOF may have a weight ratio ranging from about 1:2 to 2:1. In yet another example, the first MOF and the second MOF may have a weight ratio of 1:1. Before or after choosing a desired weight ratio, the MOFs may be sonicated (individually and/or as a mixture) to coalesce the MOFs. The coalesced sample may be separated and calcined/heated at different temperatures to obtain the desired catalyst. For example, the coalesced MOFs may be heated to a temperature ranging from 200° C. to 1000° C. In another example, the coalesced MOFs may be heated to a temperature ranging from 500° C. to 800° C. Varying the heating temperature may tune the SMSI. Heating may be include utilizing inert gas, air, ammonia, and H₂S environments.

Distinct MOF precursors may include MOF precursors with different metals and/or different organic ligands. In one example, a first MOF may include Ni-BDC MOF, and a second MOF may include La-BDC MOF. For example, the formed catalyst may include Ni/NiO/Ni₃C phases and Ni/NiO/Ni₃C phases supported on a La₂O₃/La₂O₂CO₃ carrier induced by SMSI. The formed catalyst may include Ni supported by La(OH)₃. In one example, the energy released during decomposition of the MOFs at elevated temperatures and the prior interactions between the MOFs can dictate the structure, morphology, composition, and metal-support interactions of the developed catalysts.

The catalyst may include a lanthanum support including one or more of lanthanum oxycarbonate, lanthanum oxide, and lanthanum hydroxide. For example, the catalyst may include all of lanthanum oxycarbonate, lanthanum oxide, and lanthanum hydroxide. The catalyst may include a lanthanum support including two or more of lanthanum oxycarbonate, lanthanum oxide, and lanthanum hydroxide. Further, the catalyst may include nanoparticles including one or more of a transition metal and a transition metal oxide. These nanoparticles may be in contact with the lanthanum support sufficient for SMSI and may include nickel and nickel oxide. The nanoparticles may be lanthanide-free and actinide-free (and/or oxides thereof). In one example, the nanoparticles are impregnated within pores of the lanthanum support. In another example, the nanoparticles are attached to an outer surface of the lanthanum support.

Due to the unique methods of forming the catalyst, the catalyst can have a good distribution of metal elements with strong interactions. For example, metal/metal oxide nanoparticles may be embedded in a metal-based support with SMSI. In one example, the diameter of the nanoparticles may range from about 5 nm to about 300 nm. In another example, the diameter of the nanoparticles may range from about 10 nm to about 100 nm. In yet another example, the diameter of the nanoparticles may range from about 10 nm to about 20 nm. SMSI may contribute and assist in forming the nanoparticles with these diameters. SMSI can be vital for species diffusion and electron flow. Importantly, the catalyst with SMSI can reduce coking and improve conversion stability. The catalyst can be utilized for various reactions and adsorption applications with negligible carbon formation. Further, the catalyst may have strong basic sites, which can be beneficial for methane reforming and CO₂ reduction reactions as the catalysts can have a greater interaction with CO₂.

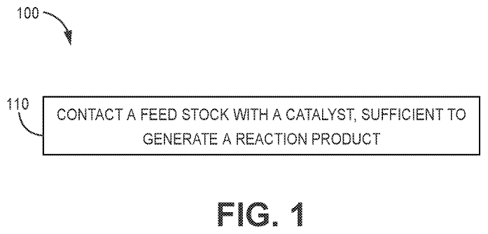

Referring to FIG. 1, a method 100 of processing a feed stock is illustrated. Method 100 includes the following steps:

STEP 110, CONTACT A FEED STOCK WITH A CATALYST, SUFFICIENT TO GENERATE A REACTION PRODUCT, includes contacting a feed stock, such as carbon dioxide and methane, with a catalyst of the present disclosure, sufficient to generate a reaction product such as hydrogen and carbon monoxide. In one example, the catalyst is derived/formed from two MOF precursors, wherein the MOF precursors are coalesced by sonication. The coalesced MOF precursors may be heated at various temperatures to form the catalyst. The catalyst may be formed with MOFs including various organic ligands.

The catalyst may include a lanthanum support including one or more of lanthanum oxycarbonate, lanthanum oxide, and lanthanum hydroxide. For example, the catalyst may include all of lanthanum oxycarbonate, lanthanum oxide, and lanthanum hydroxide. Further, the catalyst may include nanoparticles including one or more of a transition metal and a transition metal oxide. These nanoparticles may be in contact with the lanthanum support sufficient for SMSI and may include nickel and nickel oxide. The nanoparticles may be lanthanide-free and actinide-free. In one example, the nanoparticles are impregnated within pores of the lanthanum support. In another example, the nanoparticles are attached to an outer surface of the lanthanum support.

The adsorption capability of the catalyst may be tuned by, for example, varying the different organic ligands in the MOF. The SMSI assists in tuning the structure and performance of the catalyst. The feed stock may include one or more of carbon dioxide, methane, hydrogen, nitrogen, and water steam. The reaction product may include one or more of hydrogen, carbon monoxide, methanol, methane, dimethyl ether, and ammonia. The catalyst may be utilized for a reaction selected from dry reforming of methane, stream reforming of methane, carbon dioxide reduction reaction, and nitrogen reduction reaction.

STEP 110 may include utilizing the catalyst of the present disclosure for various feed stocks, reactions, and adsorption applications. For example, the catalyst may be utilized for dry reforming of methane (DRM), CO₂ reduction reaction (CRR), N₂ reduction reaction (NRR), and CO₂ adsorption. Dry reforming of methane involves producing carbon monoxide and hydrogen reaction products from methane and carbon dioxide feed stocks. These produced synthesis gas from DRM can be further transformed to various hydrocarbon fuels. CO₂ reduction reaction involves utilizing carbon dioxide and hydrogen as a feed stock to produce one or more reaction products selected from formic acid, water, carbon monoxide, methane, methanol, and dimethyl ether. N₂ reduction reaction involves utilizing a nitrogen and hydrogen feed stock to produce an ammonia reaction product.

In one example, the initial conversion of methane with the present catalysts may be greater than 75% at 80 L·g_{cat}⁻¹·h⁻¹ gas hourly space velocity (GHSV) while being coke-resistant. In another example, the initial conversion of methane with the present catalysts may be greater than 85% at 50 L·g_{cat}⁻¹·h⁻¹ GHSV while being coke-resistant. In yet another example, the conversion of methane after 24 hours of DRM with the present catalysts may be greater than 80% at 50 L·g_{cat}⁻¹·h⁻¹ GHSV while being coke-resistant. Increasing the GHSV from 50 to 80 only resulted in a slight decrease in conversion rate. This suggests that the effect of external mass transfer is very minimal in these ranges of GHSVs. Further, the present catalysts have greater stability in conversion rates compared to traditional catalysts. The weight of catalyst may be adjusted according to the GHSV and the particular application.

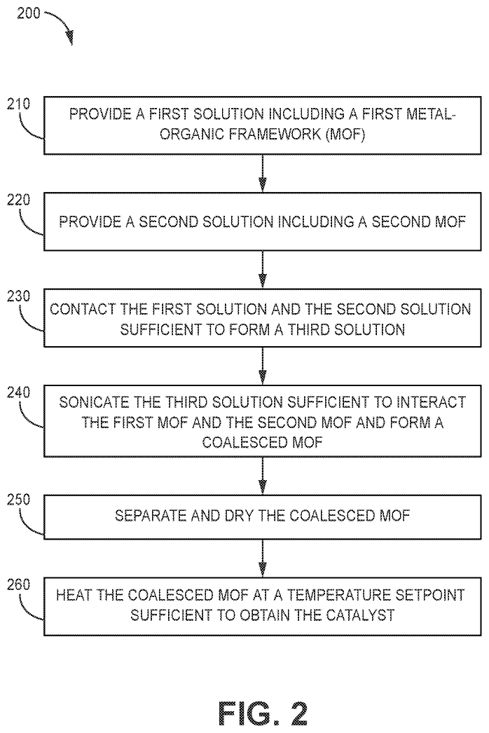

Referring to FIG. 2, a method 200 of making a catalyst, such as the catalyst utilized in method 100, is illustrated. Method 200 includes the following steps:

STEP 210, PROVIDE A FIRST SOLUTION INCLUDING A FIRST METAL-ORGANIC FRAMEWORK (MOF), includes providing a first solution including a first MOF, including a metal and organic ligand. In one example, the first MOF may include metals, transition metals, noble metals, lanthanoids, and actinoids. For example, the first MOF may include a metal selected from lanthanum, cerium, silicon, zirconium, aluminum, silver, gold, ruthenium, rhenium, platinum, palladium, samarium, nickel, and cobalt. In another example, the first MOF includes an organic ligand. For example, the first MOF may include an organic ligand selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), and BPY (2,2′-bipyridine). In one example, the concentration of the MOF in the first solution may range from 1 mg/mL to 100 mg/mL. In another example, the concentration of the MOF in the first solution may range from about 3 mg/mL to about 40 mg/mL. For example, the concentration of the MOF in the first solution may range from about 5 mg/mL to about 15 mg/mL.

The first MOF may be synthesized using a metal salt such as nickel nitrate hexahydrate and an organic ligand such as BDC. For example, nickel nitrate hexahydrate and BDC may be dissolved in water and a solvent such as N,N-dimethyl formamide (DMF) respectively. The solutions can be mixed and stirred. After, the final solution may be heated. The MOF may be collected by washing with an alcohol (such as ethanol) and drying in open air. The first MOF may be sonicated individually. For example, sonication may include ethanol. Sonication may include applying an ultrasonic frequency, such as sound energy, to a liquid and/or solid. Sonication may be completed with a sonicator, an ultrasonic bath, and/or an ultrasonic probe sonicator. Sonication can be used for exfoliation and may include mixing. Sonication may include creating vibrations with ultrasonic frequencies. In one example, the first MOF may be sonicated for 15 minutes to 3 hours. For example, the first MOF may be sonicated for about an hour;

STEP 220, PROVIDE A SECOND SOLUTION INCLUDING A SECOND MOF, includes providing a second solution including a second MOF, including a metal and organic ligand. In one example, the second MOF may include metals, transition metals, noble metals, lanthanoids, and actinoids. For example, the second MOF may include a metal selected from lanthanum, cerium, zirconium, aluminum, silver, gold, ruthenium, rhenium, platinum, palladium, samarium, nickel, and cobalt. In another example, the second MOF includes an organic ligand. For example, the second MOF may include an organic ligand selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), and BPY (2,2′-bipyridine). In one example, the concentration of the MOF in the second solution may range from 1 mg/mL to 100 mg/mL. In another example, the concentration of the MOF in the second solution may range from about 3 mg/mL to about 40 mg/mL. For example, the concentration of the MOF in the second solution may range from about 5 mg/mL to about 15 mg/mL.

The second MOF may be synthesized using a metal salt such as lanthanum nitrate hexahydrate and an organic ligand such as BDC. For example, lanthanum nitrate hexahydrate and BDC may be dissolved in a solvent such as DMF and heated. The MOF may be collected by washing with an alcohol (such as ethanol) and drying in open air. The second MOF may be sonicated individually. For example, sonication may include ethanol. In one example, the second MOF may be sonicated for 15 minutes to 3 hours. For example, the second MOF may be sonicated for about an hour;

STEP 230, CONTACT THE FIRST SOLUTION AND THE SECOND SOLUTION SUFFICIENT TO FORM A THIRD SOLUTION, includes contacting the first solution, containing the first MOF, and the second solution, containing the second MOF, sufficient to form a third solution. Contacting may include mixing, stirring, pouring, and/or heating. The first MOF and the second MOF may have a weight ratio ranging from about 1:4 to about 4:1. In another example, the first MOF and the second MOF may have a weight ratio ranging from about 1:2 to 2:1. In yet another example, the first MOF and the second MOF may have a weight ratio of 1:1;

STEP 240, SONICATE THE THIRD SOLUTION SUFFICIENT TO INTERACT THE FIRST MOF AND THE SECOND MOF AND FORM A COALESCED MOF, includes sonicating the third solution, a solution including the first solution and the second solution, sufficient to interact the first MOF and the second MOF and form a coalesced MOF. In one example, a coalesced MOF has come together to form one structure. For example, a coalesced MOF may include two or more MOFs that have come together to form one group or mass. Sonication of the third solution promotes coalesced MOFs with strong interactions between the involved MOF structures, which can produce metal supported catalysts with tunable SMSI. In another example, sonication can be utilized to exfoliate the MOFs into nanosheets. Exfoliated sheets can have more active coordination to facilitate better interactions. Sonication can cause a shift in diffraction peaks toward lower angles. Further, sonication can cause additional diffraction peaks. The lower angle shift indicates exfoliation and strong interaction between the MOFs. Further, coalesced MOFs may have stronger exothermic peaks compared to physically mixed MOFs due to the strong interaction during sonication;

STEP 250, SEPARATE AND DRY THE COALESCED MOF, includes separating (such as centrifugation) and drying, such as heating, the coalesced MOF. In one example, separating includes centrifugation at any speed sufficient to separate the coalesced MOF. Drying may include heating at a temperature setpoint for a desired time. For example, drying may include heating the coalesced MOF at/to a temperature ranging from 50° C. to 150° C. Drying may include heating the coalesced MOF for an hour or more. For example, drying may be completed in 5 hours to 15 hours;

STEP 260, HEAT THE COALESCED MOF AT A TEMPERATURE SETPOINT SUFFICIENT TO OBTAIN THE CATALYST, includes heating the coalesced MOF, such as a dried coalesced MOF, at a temperature setpoint to obtain the desired catalyst. Heating may be included in a calcining (thermal treatment) process. The coalesced MOFS can be calcined at different temperatures. For example, the coalesced MOF is calcined at a temperature ranging from 200° C. to 1000° C. The coalesced MOF may be calcined at a temperature ranging from 250° C. to 800° C. The coalesced MOF may be calcined at a temperature ranging from 500° C. to 600° C. The coalesced MOF may be calcined at a temperature greater than 400° C. In one example, the coalesced MOF may be heated for 30 minutes to 6 hours. For example, the coalesced MOF may be heated for 1 hour to 3 hours. Various heating rates may be utilized in the heating process. The coalesced MOF may be heated at a rate ranging from 2° C./min to 20° C./min. For example, the coalesced MOF may be heated at a rate ranging from 8° C./min to 12° C./min. The coalesced MOF may be heated in open air atmosphere. Calcining may be include utilizing inert gas, air, ammonia, and H₂S environments. In one example, the catalyst may include a support selected from lanthanum oxide, lanthanum hydroxide, and lanthanum oxycarbonate. For example, the catalysts may be reduced sufficient to form a lanthanum hydroxide support. As compared to traditional catalysts, the present catalysts exhibit different reduction phenomenon due to the strong interaction between the MOFs. Nanosized nanoparticles may be highly dispersed on the support due to SMSI. For example, nanoparticles with a diameter ranging from 5 nm to 25 nm may be highly dispersed on the support due to SMSI. Nanoparticles with a diameter ranging from 10 nm to 20 nm may be highly dispersed on the support.

Importantly, heating at various temperatures can produce catalysts with tuned SMSI. Various temperatures and MOFs can be utilized to tune the catalyst for various reactions and applications. For example, a heating temperature of 500° C. may form a catalyst that has higher conversions for a specific application compared to heating at a temperature of 400° C. Further, the heating temperature can be tuned according to the exothermic peak of the MOF. In one example, the coalesced MOF powder may be calcined at a sufficient temperature to remove remnants of MOF structure in the final catalyst. The heating temperature may be sufficient to complete a simultaneous decomposition of the MOFs. The thermal energy at high temperatures can avail the strong interactions between the phases. These interactions can create a defected structure due to a lattice mismatch between the phases and/or infusion of one phase into the other. These stacking faults can assist in controlling the catalytic reactions. Further, the catalyst may be free of any MOF structure/coordination.

### Example 1

First, Ni(NO₃)₂·6H₂O and BDC (Benzene-1,4-dicarboxylic acid) were dissolved in a 3:1 mole ratio in 60 mL of deionized water and 60 mL of DMF (N,N-dimethyl formamide), respectively. Both solutions were then mixed and stirred vigorously for 30 minutes at room temperature. Afterwards, the final solution was placed into a Teflon-lined autoclave and heated for 24 hours at 100° C. Further, the autoclave was cooled down to room temperature and the light green solid of Ni-BDC MOF was collected by washing with ethanol three times and dried at 85° C. for 20 hours in open air atmosphere.

Briefly, a 2:1 mole ratio of La(NO₃)₂·6H₂O and BDC were dissolved in 120 mL of DMF and stirred vigorously for 30 minutes at room temperature to achieve a clear solution. Afterward, the solution was transferred into a Teflon-lined autoclave and heated at 120° C. for 48 hours. Further, the autoclave was cooled down to room temperature and the white solid of La-BDC MOF was collected by washing with ethanol three times and dried at 85° C. for 15 hours in open air atmosphere.

The MOF derived catalysts were obtained by sonication followed by calcination of the prepared Ni-BDC and La-BDC MOFs. Both Ni-BDC MOF and La-BDC MOFs (10 mg/mL) were sonicated individually in 10 mL of ethanol for 1 hour to get exfoliate, and then both solutions were mixed and further sonicated for 1 hour to form the coalesced MOFs with strong interactions. After sonication, the coalesced sample was collected by centrifugation followed by drying at 80° C. for 12 hours. To obtain the final catalysts, the dried, coalesced MOFs were calcined at different temperatures (250, 400, 500, 600, and 800° C.) for 2 hours at a heating rate of 10° C./min in open air atmosphere. The obtained catalysts are named as Ni—La-250, Ni—La-400, Ni—La-500, Ni—La-600, and Ni—La-800, respectively. Further, Ni-BDC and La-BDC MOFs in a 1:1 weight ratio were physically mixed and calcined at 500° C. using the above procedure for comparison studies. The obtained comparison catalyst is named as Ni—La-500-PM.

A conventional catalyst was prepared by the wetness impregnation method. In brief, 2.478 grams of Ni(NO₃)₂·6H₂O was added to 10 mL of DI water and stirred until the solution was clear. Further, 2.0 grams of La₂O₃ powder was added to the above solution and stirred vigorously to achieve a homogeneous solution and then dried at 80° C. The dried powder was calcined at 500° C. for 2 hours in open air atmosphere at a 10° C./min heating rate. The final catalyst was collected after being cooled down to room temperature and named as Ni—La-500-WI (wetness impregnation).

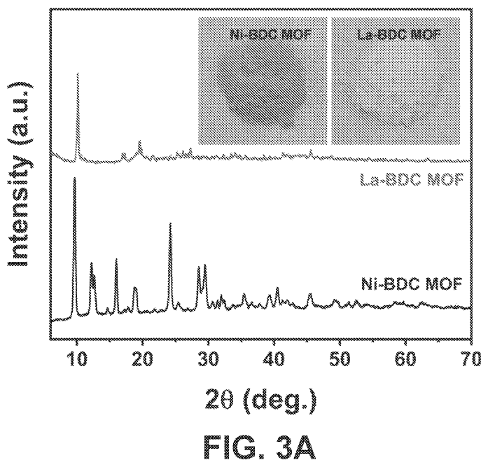

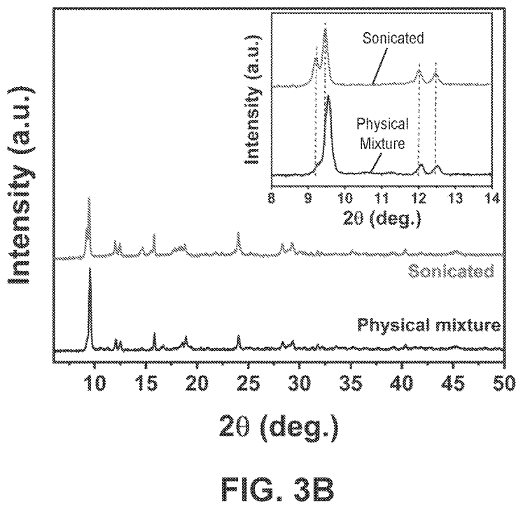

FIG. 3A illustrates XRD patterns of as-synthesized Ni-BDC and La-BDC MOFs, with inset images illustrating the respective powders, according to some embodiments. The XRD patterns exhibit highly crystalline nature and confirm the successful synthesis of MOF structures. Further, both MOFs were coalesced using the sonication technique in order to achieve strong interactions between the involved MOF structures, which in turn can produce metal supported catalysts with tunable SMSI phenomena. Exfoliated sheets can have more active coordination to facilitate better interaction among the separated layers. Both MOFs were sonicated in ethanol to establish a strong interaction between the MOFs.

FIG. 3B illustrates XRD patterns of a physical mixture and sonicated samples of Ni-BDC and La-BDC MOFs in a 1:1 weight ratio, with the inset image illustrating a shift in the sonicated sample toward lower angle shift, indicating interaction between the MOFs, according to some embodiments. The coalesced MOFs by sonication show a shift in the diffraction peaks towards lower angles along with the emergence of an additional peak appearing at 9.1° as compared to the diffraction pattern of the MOF physical mixture. The lower angle shift clearly indicates the exfoliation and the strong interaction between the MOFs during the sonication process.

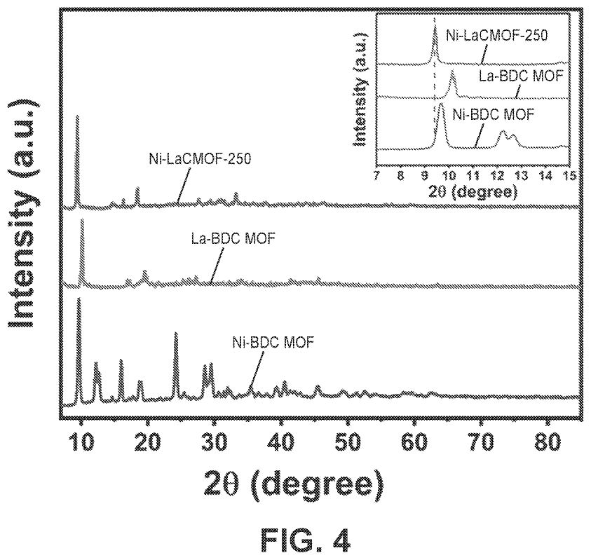

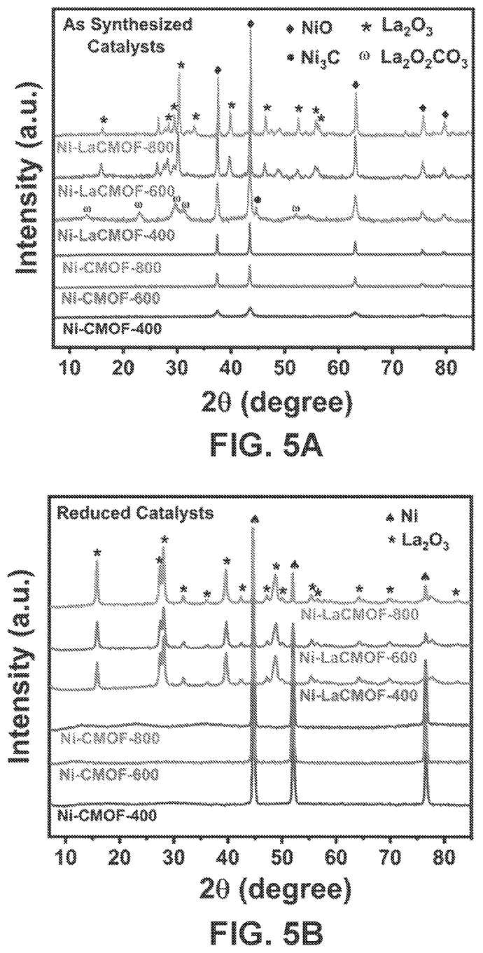

FIG. 4 illustrates XRD patterns of Ni-BDC, La-BDC MOFs, and the coalesced Ni-&La-BDC MOFs calcined at 250° C. with the inset image illustrating lower-angle shift in the coalesced sample and the sample being in MOF phase, according to some embodiments. Calcined MOFs may be referred to as CMOF. There is a lower-angle shift in the peak position as shown in the inset, which proves there is a delamination and/or interaction of both MOFs during the coalescence process. FIG. 5A illustrates XRD patterns of Ni-BDC and coalesced Ni-&La-BDC MOFs calcined at different temperatures viz., 400, 600, and 800° C. for 2 hours, according to some embodiments. The as-synthesized catalysts show the successful formation of metal oxides and carbides of Ni(NiO and Ni₃C) and their embedment in La based supports (La₂O₃ and La₂O₂CO₃). Further, the formed catalysts were reduced at 800° C. in 5% H₂ atmosphere for 2 hours. FIG. 5B illustrates XRD patterns of Ni-BDC and coalesced Ni-&La-BDC MOFs calcined at different temperatures viz., 400, 600, and 800° C. after reduction at 800° C. for 2 hours, according to some embodiments. The reduction process converts all the metal oxide and carbide phases to pure metal (Ni) phase and the support in to La₂O₃ phase. Therefore, pure metals, metal oxides, metal carbides on lanthanum oxide and oxycarbonate supports were successfully synthesized.

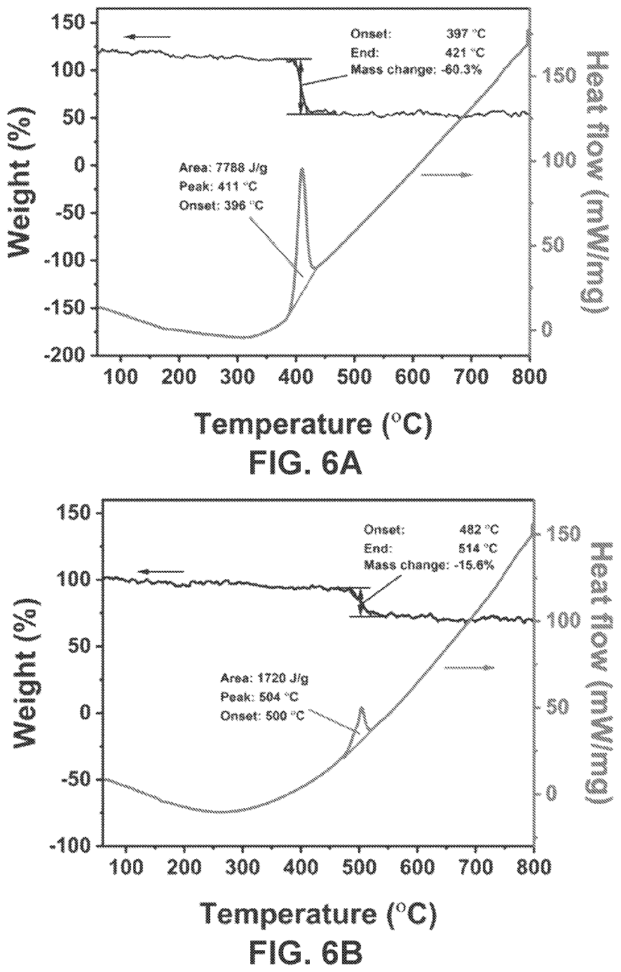

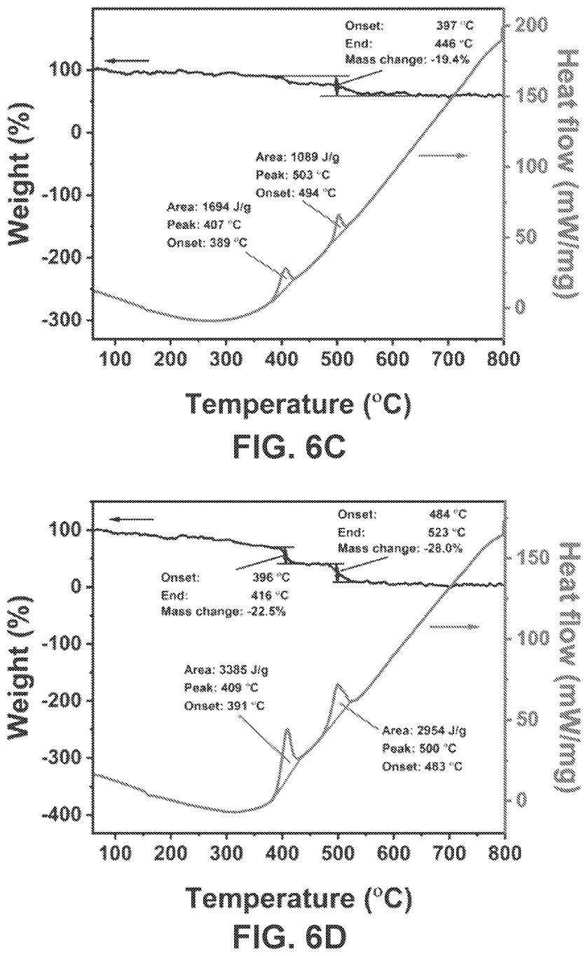

FIG. 6A illustrates DSC-TGA profiles of Ni-BDC MOF in oxygen atmosphere, according to some embodiments. FIG. 6B illustrates DSC-TGA profiles of La-BDC MOF in oxygen atmosphere, according to some embodiments. FIG. 6C illustrates DSC-TGA profiles of a Ni-BDC MOF/La-BDC MOF physical mixture in oxygen atmosphere in a 1:1 weight ratio, according to some embodiments. FIG. 6D illustrates DSC-TGA profiles of sonicated Ni-BDC MOF/La-BDC MOF in oxygen atmosphere in a 1:1 weight ratio, according to some embodiments.

The coalesced MOF powder was calcined in air atmosphere (heating rate: 10° C./min) to obtain the supported nickel catalysts. The selection of calcination temperature was inferred from the DSC-TGA analysis in oxygen atmosphere of the individual and coalesced MOFs. It is evident that the Ni-BDC MOF exhibited a strong exothermic peak as compared to that of La-BDC MOF and both MOFs were disintegrated on or before 500° C. Hence, the calcination temperature for synthesizing the supported catalysts was chosen as 500° C. The coalesced MOF powder was calcined at 500° C. for 2 hours (named as Ni—La-500) to make sure that no remnants of MOF structure is present in the final catalysts. Further, the coalesced MOFs have shown strong exothermic peaks compared to that of physically mixed MOFs. This is due to the strong interaction occurred between the MOFs during the sonication process, which further supports the XRD analysis shown in FIG. 3B.

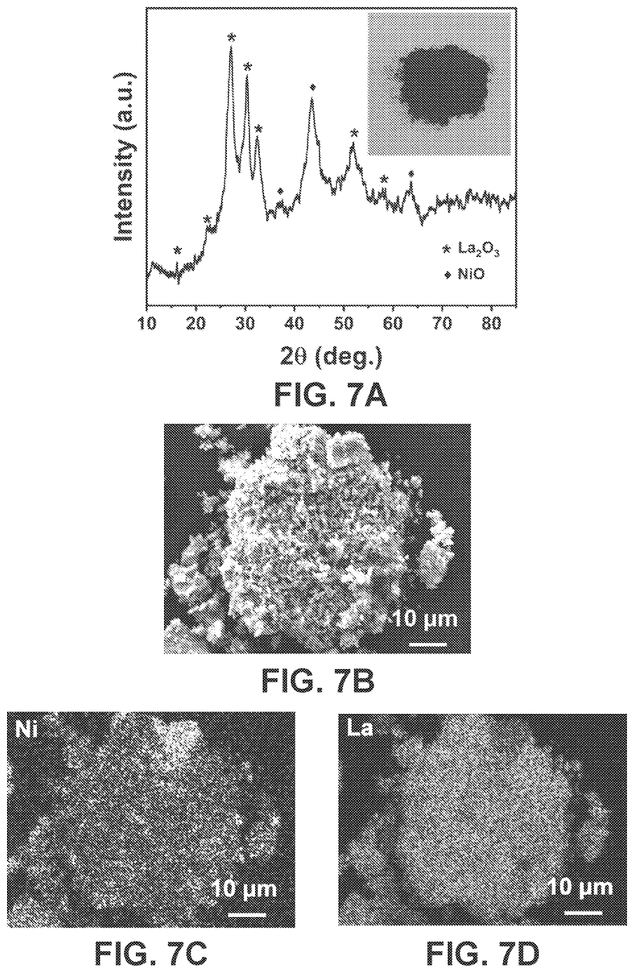

FIG. 7A illustrates an XRD pattern of as-synthesized Ni—La-500-WI (wetness impregnation) catalyst, with the inset illustrating the powder sample image, according to some embodiments. The physical mixture was also calcined at the same temperature (named as Ni—La-500-PM) to obtain the supported catalyst. The catalyst obtained from the physical mixture is used for all comparison studies with the catalysts produced from the coalesced MOFs. The XRD pattern for the Ni—La-500 WI catalyst shows both NiO and La₂O₃ phases, which indicates the successful formation of the catalyst.

FIG. 7B illustrates an SEM image of as-synthesized Ni—La-500-WI catalyst, according to some embodiments. FIG. 7C illustrates elemental mapping of Ni in the as-synthesized Ni—La-500-WI catalyst, according to some embodiments. FIG. 7D illustrates elemental mapping of La in the as-synthesized Ni—La-500-WI catalyst, according to some embodiments. The SEM image along with the elemental distribution suggests the formation of larger size NiO phase on the La₂O₃ support.

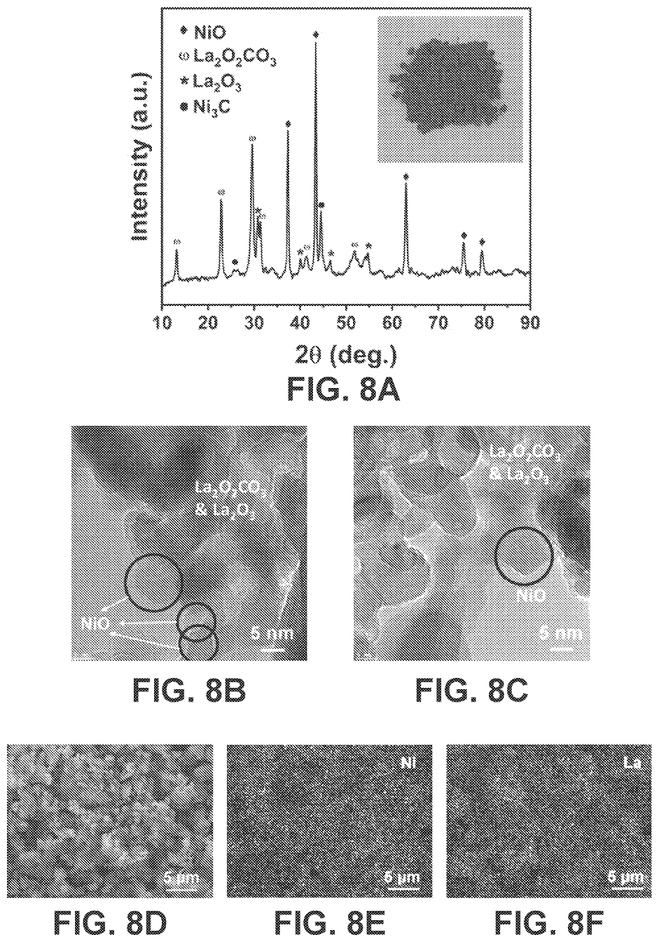

FIG. 8A illustrates an XRD of the as-synthesized Ni—La-500 catalyst, with the inset illustrating the powder sample image, according to some embodiments. The XRD reveals that the synthesized catalyst contains cubic nickel oxide (NiO) phase supported on monoclinic lanthanum oxycarbonate (La₂O₂CO₃) and hexagonal lanthanum oxide (La₂O₃ (minor phase)). The derived La₂O₂CO₃ phase formation is very interesting as explained in what follows. The thermal stability of BDC based MOFs proves that the decarboxylation (release of CO₂) of BDC ligand begins at 350° C. and about 60% of CO₂ release occurs at 380° C. when heated for 24 hours. It is also observed that most carboxylate groups are intact up to 400° C. In the present synthesis conditions, at 500° C., it would be expected that the released carboxylate groups may decompose and form only La₂O₃ as a support. However, most of the support material crystallizes as La₂O₂CO₃ along with a minor Ni₃C phase. This is because the CO₂ molecules that come out from the BDC ligand of MOFs, during the calcination, reacted with both Ni and La components and formed the respective Ni₃C and La₂O₂CO₃ phases (via the reaction shown in Equation 1), other than forming different stable Ni and La phases (e.g.: LaNiO₃, La₂NiO₄, LaNi₂O₄, and La₃Ni₂O₇).

La₂O₃+CO₂+>La₂O₂CO₃ (1)

FIG. 8B illustrates a high-resolution TEM image of the as-synthesized Ni—La-500 catalyst, according to some embodiments. FIG. 8C illustrates a high-resolution TEM image of the as-synthesized Ni—La-500 catalyst, according to some embodiments. FIG. 8B and FIG. 8C show TEM images of NiO nanoparticles (10-20 nm) embedded into the lanthanum-based support with SMSI. FIG. 8D illustrates an SEM image of as-synthesized Ni—La-500 catalyst, according to some embodiments. FIG. 8E illustrates elemental mapping of Ni in the as-synthesized Ni—La-500 catalyst, according to some embodiments. FIG. 8F illustrates elemental mapping of La in the as-synthesized Ni—La-500 catalyst, according to some embodiments.

The coalesced MOF derived catalyst (Ni—La-500) has shown good distribution of both Ni and La elements with strong interactions. Importantly, the NiO is crystallized into nanoparticles while the lanthanum phase forms the support, which may not be expected. Instead, the Ni and La atoms crystallized individually and formed NiO and La₂O₂CO₃ phases with significant interactions between them. The difference in heat release during the decomposition of the MOFs may be the reason to form the supported catalyst. From the DSC profiles of the coalesced MOFs (FIG. 6D), it is evident that the Ni-BDC MOF decomposes early and releases more heat energy compared to that of La-BDC MOF decomposition (The individual DSC profiles of the MOFs also show a huge difference in the released heat energy as shown in FIG. 6A and FIG. 6B). The fast and early decomposition of Ni-BDC MOF rapidly crystallizes and tends to form smaller NiO particles due to localized depletion (where nucleation phenomenon dominates the growth mechanism), while the La-BDC MOF forms the bigger sized support due to late and less heat energy released during the decomposition. The strong interactions established between Ni and La phases are beneficial to form a coke-free and sinter-resistant catalyst system, particularly under the severe DRM reaction conditions.

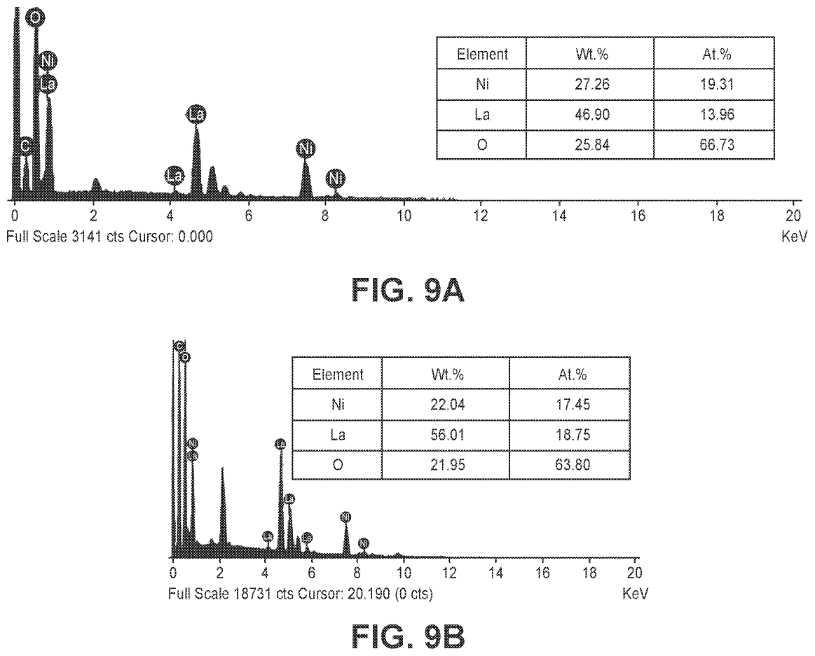

FIG. 9A illustrates SEM-EDS spectra and the corresponding elemental analysis of Ni—La-500, according to some embodiments. FIG. 9B illustrates SEM-EDS spectra and the corresponding elemental analysis of Ni—La-500-PM, according to some embodiments. FIG. 9A and FIG. 9B shows the elemental analysis and SEM-EDS spectra of both Ni—La-500 and Ni—La-500 PM catalysts and have shown almost the same amount of active metal content (˜25 wt. % Ni).

From the DSC studies of the coalesced MOFs in FIG. 6D, the highest exothermic peak appears at 500° C., which is sufficient to form the La₂O₂CO₃ phase via Equation 1. The in-situ formed La₂O₂CO₃ phase can be a superior support for DRM catalysis as it can maintain the surface of the catalyst free from carbon accumulation during the reaction.

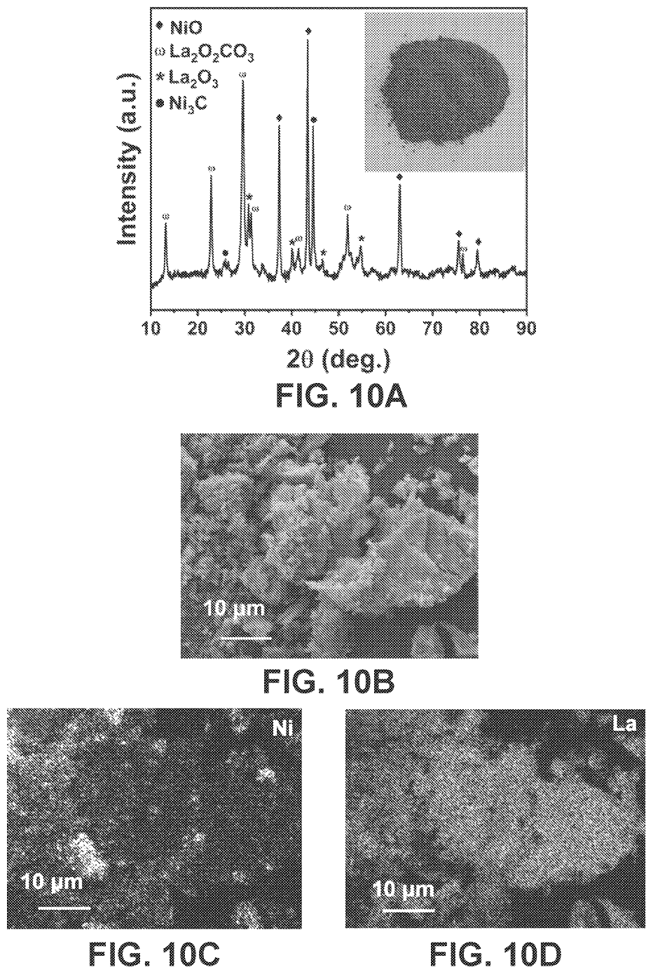

FIG. 10A illustrates an XRD pattern of as-synthesized Ni—La-500-PM catalyst, with the inset illustrating the powder sample image, according to some embodiments. The catalyst obtained out of the Ni-BDC and La-BDC physical mixture calcination has shown the same phases as that of Ni—La-500 catalyst. However, the intensity of carbon related phases (Ni₃C and La₂O₂CO₃) is much higher than that of the catalysts produced from the coalesced MOFs. FIG. 10B illustrates an SEM image of as-synthesized Ni—La-500-PM catalyst, according to some embodiments. FIG. 10C illustrates elemental mapping of Ni in the as-synthesized Ni—La-500-PM catalyst, according to some embodiments. FIG. 10D illustrates elemental mapping of La in the as-synthesized Ni—La-500-PM catalyst, according to some embodiments. It implies that the CO₂ molecules produced during the calcination process of the physical mixture MOFs reacts/interacts to a greater extent with both Ni and La phases individually (due to poor interactions between them), leading to the formation of the respective phases. This proves that by ensuring the proper interactions between the MOFs, the phase formation of the MOF derived final catalysts during calcination process can be tuned. The better interaction between the MOFs during sonication (proved from XRD, FIG. 3B) controlled the formation of carbonized phases during the calcination. Weak interactions between the MOFs individual Ni and La phases are observed in the catalyst derived from the MOF physical mixture.

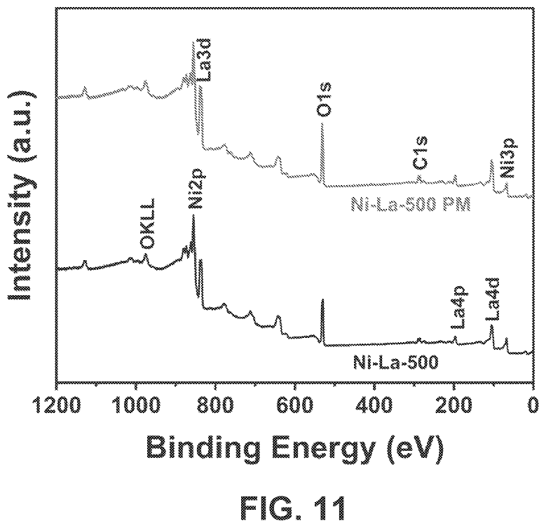

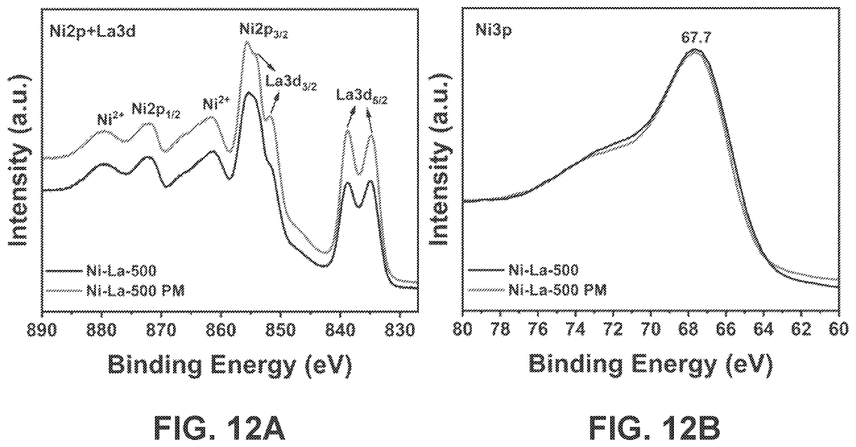

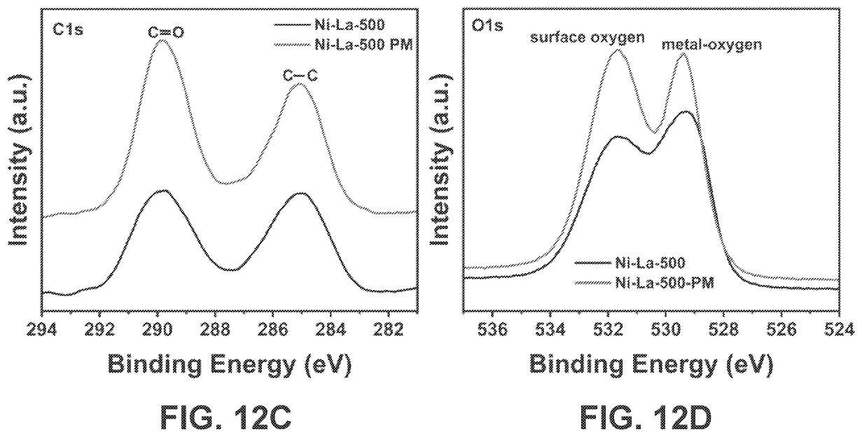

The chemical environment and functional groups of Ni—La-500 and Ni—La-500-PM catalysts were investigated using XPS spectroscopy. FIG. 11 illustrates XPS survey spectra of as-synthesized Ni—La-500 and Ni—La-500 PM catalysts, according to some embodiments, which show different elemental spin orbitals. FIG. 12A illustrates XPS spectra of as-synthesized Ni—La-500 and Ni—La-500 PM catalysts including Ni₂p and La₃d spectra, according to some embodiments. The doublet of La₃d_{5/2} is associated to the La₂O₂CO₃ phase present in both the catalysts. The Ni₂p exhibit two energy bands at 855.4 and 873.1 eV corresponding to Ni₂p_{3/2} and Ni₂p_{1/2} along with two satellite peaks at 861.2 and 879.8 eV, respectively, corresponding to Ni₂+ of NiO phase formed in the catalysts. FIG. 12B illustrates XPS spectra of as-synthesized Ni—La-500 and Ni—La-500 PM catalysts including Ni₃p spectra, according to some embodiments, showing the binding energy at 67.7 eV. Based on the Ni₃p spectra, it is shown that the as-synthesized Ni—La-500 catalyst has SMSI.

FIG. 12C illustrates XPS spectra of as-synthesized Ni—La-500 and Ni—La-500 PM catalysts including C1s spectra, according to some embodiments. The C1s XPS spectra shows two major peaks at 289.8 and 285.1 eV, corresponding to C═O and C—C bonds respectively. The peak corresponding to the C═O bond belongs to the carbonate chemical environmental in the La₂O₂CO₃ support; this peak appears higher in the case of the Ni—La-500-PM catalyst as compared to the Ni—La-500 catalyst. The latter may be due to the formation of a higher amount of carbonate phase (evident from the XRD, FIG. 10A). FIG. 12D illustrates XPS spectra of as-synthesized Ni—La-500 and Ni—La-500 PM catalysts including O1s spectra, according to some embodiments. The O1s XPS spectra shows two characteristic peaks at 531.7 and 529.4 eV, corresponding to surface oxygen (O_{surf}) and metal-oxygen (M-O) environment, respectively. The peak area ratios of M-O to O_{surf} for Ni—La-500 and Ni—La-500 PM catalysts are 0.83 and 0.64 respectively. The presence of a higher peak area of the metal-oxygen bond in Ni—La-500 catalyst compared to the Ni—La-500 PM catalyst might be due to the formation of SMSI via the oxygen from the support.

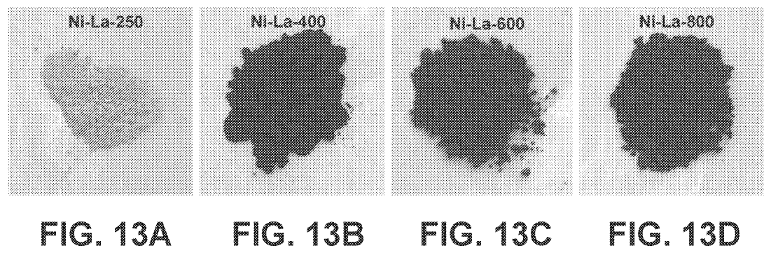

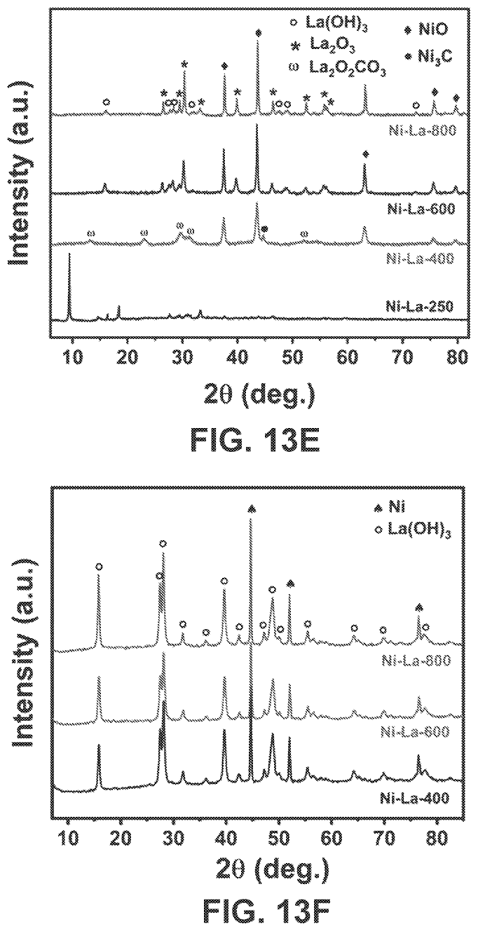

The tunability of the MOF derived catalysts not only depends upon the interactions between the MOFs prior to calcination but also the calcination temperature. To understand the effect of calcination temperature on the MOF derived catalysts, the coalesced MOFs were calcined at different temperatures viz., 250, 400, 600, and 800° C. The obtained catalysts were named as Ni—La-250, Ni—La-400, Ni—La-600, and Ni—La-800 respectively. FIG. 13A illustrates a powder image of Ni—La-250 where the synthesized catalyst is calcined at 250° C., according to some embodiments. FIG. 13B illustrates a powder image of Ni—La-400 where the synthesized catalyst is calcined at 400° C., according to some embodiments. FIG. 13C illustrates a powder image of Ni—La-600 where the synthesized catalyst is calcined at 600° C., according to some embodiments. FIG. 13D illustrates a powder image of Ni—La-800 where the synthesized catalyst is calcined at 800° C., according to some embodiments.

FIG. 13E illustrates XRD patterns of synthesized Ni—La-250, Ni—La-400, Ni—La, 600, and Ni—La-800, according to some embodiments. FIG. 13F illustrates XRD patterns of reduced Ni—La-400, Ni—La-600, and Ni—La-800, according to some embodiments. In the case of the coalesced MOFs calcined at only 250° C., the MOF phase was still the predominant one. It is evident that the decomposition of MOFs (with BDC organic ligand) starts above 300° C., and hence Ni—La-250 still exists in MOF phase.

The XRD pattern of Ni—La-400 catalyst shows pure La₂O₂CO₃ and NiO along with minor Ni₃C phase. This is because the released CO₂ molecules during decarboxylation are intact up to 400° C., and hence most of these molecules interacted with the La phase and formed an La₂O₂CO₃ phase due to the high basicity of the latter. As the temperature increases from 400 up to 800° C., the La₂O₂CO₃ phase converted into La₂O₃ with a minor La(OH)₃ phase. It is also observed that, a minor La₂O₃ phase is also formed in Ni—La-500 catalysts. This observation implies that, as the synthesis temperature increased from 400 to 800° C., the CO₂ molecules expelled out and formed an La₂O₃ phase. The formation of minor the La(OH)₃ phase in Ni—La-600 and Ni—La-800 catalysts is due to the hydroxylation of La₂O₃ phase with water molecules in air atmosphere, after cooling down the calcined samples to room temperature by following Equation 2.

La₂O₃+3H₂O↔2La(OH)₃ (2)

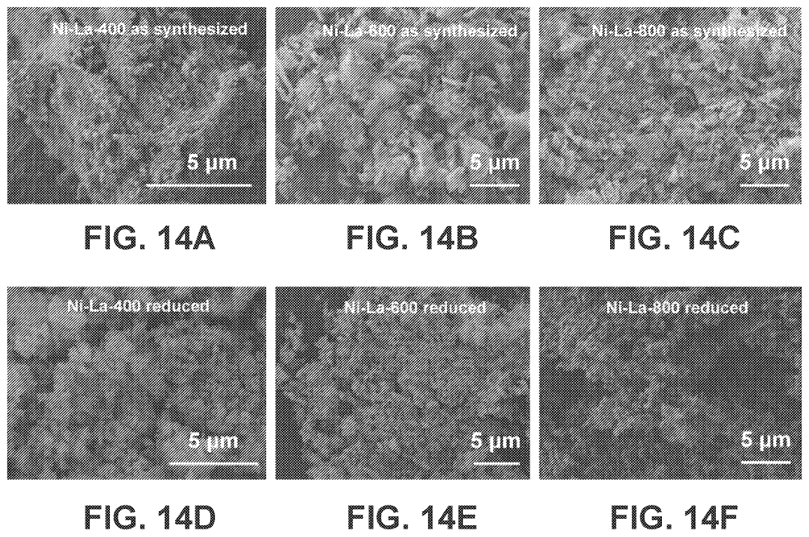

FIG. 14A illustrates an SEM image of as-synthesized Ni—La-400, according to some embodiments. FIG. 14B illustrates an SEM image of as-synthesized Ni—La-600, according to some embodiments. FIG. 14C illustrates an SEM image of as-synthesized Ni—La-800, according to some embodiments. From the micrographs, it is visible that the morphology has been changed drastically as the calcination temperature of the synthesis increases from 400 to 800° C. The Ni—La-400 catalyst shows small size particles, whereas the Ni—La-600 and Ni—La-800 catalysts shows micron sized flake type structures. The change of morphology and the interactions between the formed phases is highly interesting. To understand these aspects, a detailed TEM analysis was performed on as-synthesized Ni—La-800 catalyst.

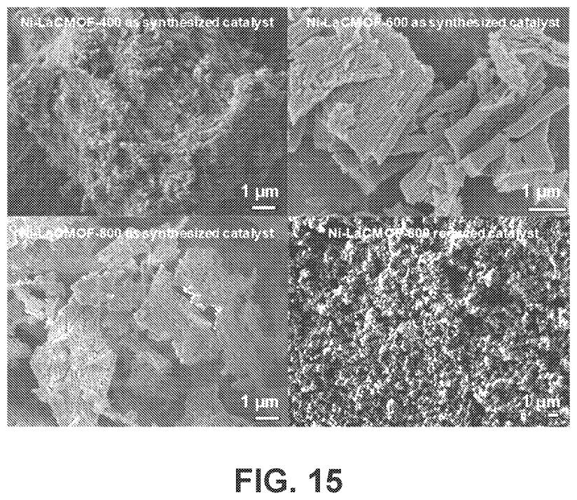

FIG. 14D illustrates an SEM image of reduced Ni—La-400, according to some embodiments. FIG. 14E illustrates an SEM image of reduced Ni—La-600, according to some embodiments. FIG. 14F illustrates an SEM image of reduced Ni—La-800, according to some embodiments. FIG. 15 illustrates SEM images of as-synthesized coalesced Ni-&La-BDC MOFs calcined at different temperatures viz., 400, 600, 800° C. and reduced 800° C. sample, according to some embodiments. The samples show the formation of nanoparticles with a porous nature. As the temperature is increased from 400 to 800° C., the particle size increased due to more time for the crystal growth during heating. The reduced Ni—La MOF-800 sample shows the similar behavior of having porous nature.

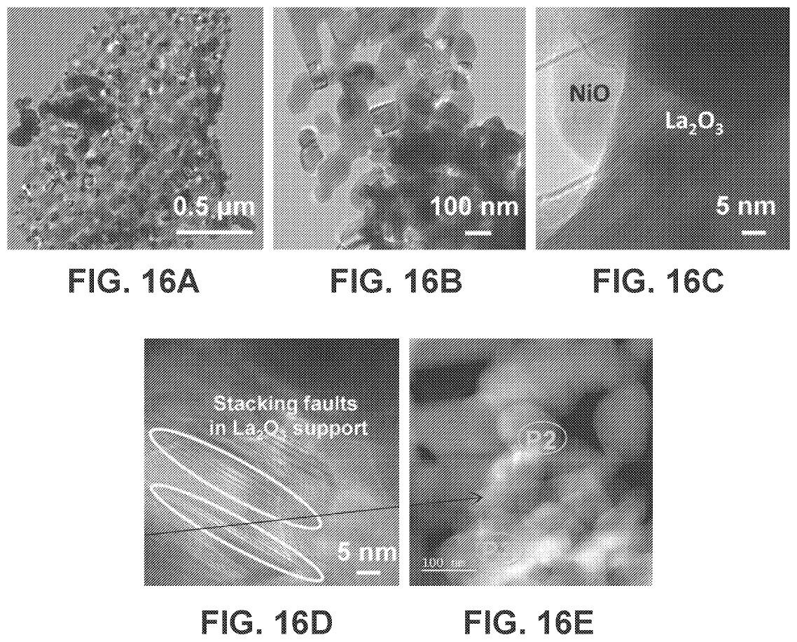

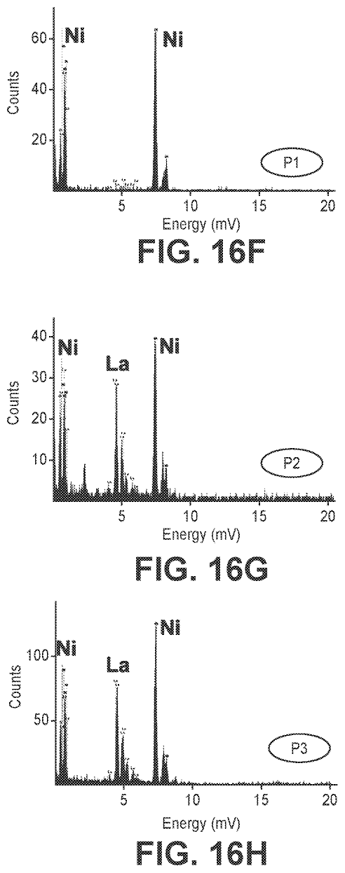

FIG. 16A illustrates a TEM analysis of the as-synthesized Ni—La-800 catalyst, showing the formation of 100 nm to 200 nm particles of the catalyst, according to some embodiments. FIG. 16B illustrates a TEM analysis of the as-synthesized Ni—La-800 catalyst, showing the formation of 100 nm to 200 nm particles of the catalyst, according to some embodiments.

FIG. 16C illustrates a TEM analysis of the as-synthesized Ni—La-800 catalyst, showing an embedded NiO nanoparticle (˜20 nm in size) in the La₂O₃ support, confirming the SMSI, according to some embodiments. The high-resolution TEM image shows the strongly embedded NiO nanoparticles (˜20 nm size) into La₂O₃ support. The thermal energy at high temperatures avails the strong interactions between both phases. These interactions can create a defected structure due to lattice mismatch between the phases and/or infusion of one phase into the other. FIG. 16D illustrates a TEM analysis of the as-synthesized Ni—La-800 catalyst, showing the formation of stacking faults in the La₂O₃ phase, according to some embodiments. The high temperature treatment induced the fault formation which assists in active sites for adsorption. This phenomenon is evident from FIG. 16D where two-dimensional stacking (2D) faults in the La₂O₃ support are observed. These kind of stacking faults are highly desired in catalysis as they can control the catalytic reactions. For example, the Ruddlesden-Popper stacking faults (one kind of 2D defects) formed in the LaFeO₃ phase have enhanced the CO oxidation catalysis. Previously, creating and controlling the stacking faults in the catalyst presented a very high synthetic challenge.

FIG. 16E illustrates the STEM image used for the EDS analysis at three different points to know the co-existence of Ni and La phases, according to some embodiments. FIG. 16F illustrates the corresponding EDS spectra with P1 showing the pure Ni phase, according to some embodiments. FIG. 16G illustrates the corresponding EDS spectra with P2 showing the Ni and La phases, according to some embodiments. FIG. 16H illustrates the corresponding EDS spectra with P3 showing the Ni and La phases, according to some embodiments. The current synthesis approach not only can fabricate the desired catalysts, but also can alter the microstructure. The infusion can also be observed from FIG. 16E.

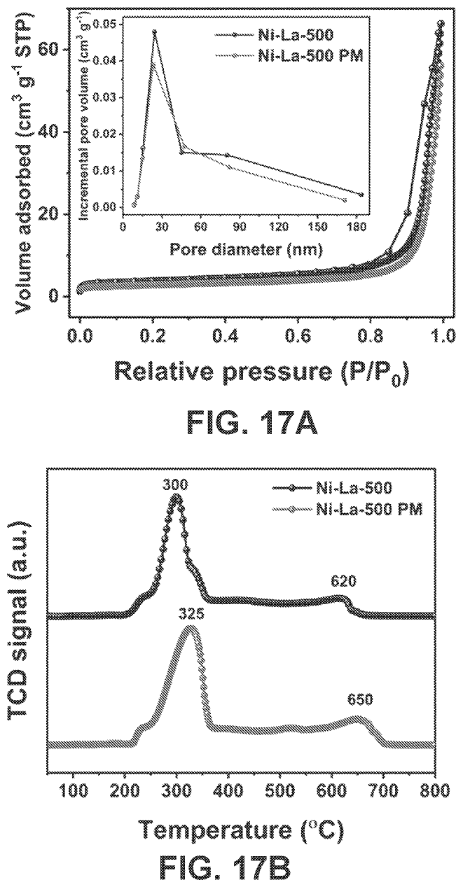

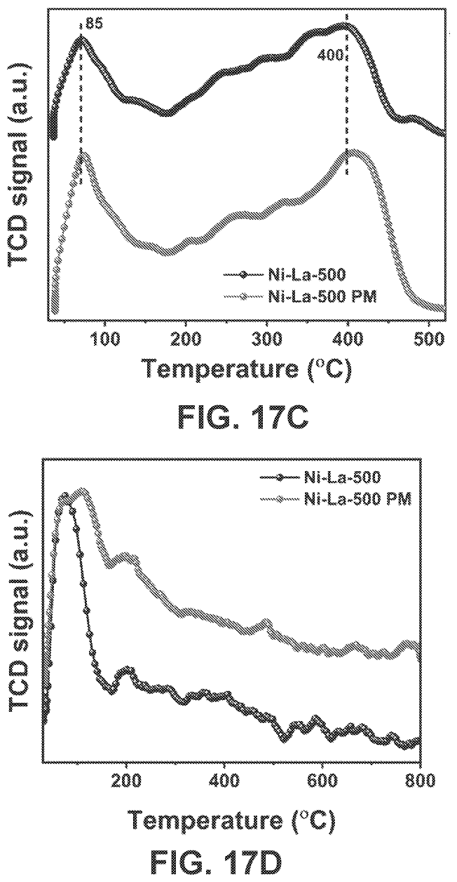

FIG. 17A illustrates an N₂ adsorption-desorption isotherm (inset shows the pore size distribution) of as-synthesized Ni—La-500 and Ni—La-500 PM catalysts, according to some embodiments. FIG. 17B illustrates H₂-Temperature programed reduction (H₂-TPR) of as-synthesized Ni—La-500 and Ni—La-500 PM catalysts, according to some embodiments. Both the catalysts show two major reduction peaks around 300 and 600° C. corresponding to the reduction of NiO and decomposition of La₂O₂CO₃ support respectively. The occurrence of NiO reduction at 300° C. in case of Ni—La-500 catalyst is due to the strong interactions of NiO phase with the support (SMSI), whereas the weakly bounded NiO reduce at very low temperatures.

FIG. 17C illustrates CO₂-Temperature programed desorption (CO₂-TPD) of as-synthesized Ni—La-500 and Ni—La-500 PM catalysts, according to some embodiments. Both catalysts exhibit a bimodal distribution of alkaline sites with peaks at 85 and 400° C. and desorbed the same quantity (0.04 mmol/g) of CO₂ molecules. The desorbed CO₂ molecules below and above 200° C. represent weak and strong alkaline sites of the catalysts, respectively. Comparatively, the Ni—La-500 catalyst has more strong alkaline sites (more peak area above 200° C.) than that of Ni—La-500 PM catalyst. The weak to strong alkaline peak area ratios are 0.85 and 0.91 for Ni—La-500 and Ni—La-500 PM catalysts respectively. The presence of strong alkaline sites is beneficial for the activation of CO₂ molecules during the DRM reaction to achieve better catalytic activity. The presence of higher strong alkaline sites is not always expected even with the most common basic supports based on Mg, Ca, and La.

FIG. 17D illustrates H₂-Temperature programed desorption (H₂-TPD) profiles of as-synthesized Ni—La-500 and Ni—La-500 PM catalysts, according to some embodiments. Both catalysts have shown a low-temperature H₂ desorption peak at around 100° C. This peak is attributed to the chemisorbed hydrogen molecules on highly dispersed Ni nanoparticles of the catalysts. It is interesting that the Ni—La-500 catalyst has shown only one peak around 100° C., without any peaks at higher temperatures, which implies that the Ni nanoparticles are well dispersed (monodispersed) onto lanthanum-based support. However, the Ni—La-500 PM catalyst exhibit two peaks at 100° C. along with broad peak extended to high temperatures. The high temperature peak corresponds to the H₂ molecules that are adsorbed on the surface of bulk Ni particles (evident from SEM-EDS analysis, FIGS. 10A-10D). From SEM and H₂-TPD analyses, it is evident that Ni—La-500 catalyst has a better dispersion of Ni nanoparticles on the lanthanum support coupled with SMSI. The chemisorption measurements have shown strong differences between the Ni—La-500 and Ni—La-500 PM catalysts. It is strongly evident that the formation of MOF derived supported catalysts can be tuned by creating the strong interactions between the MOFs and calcination temperature.

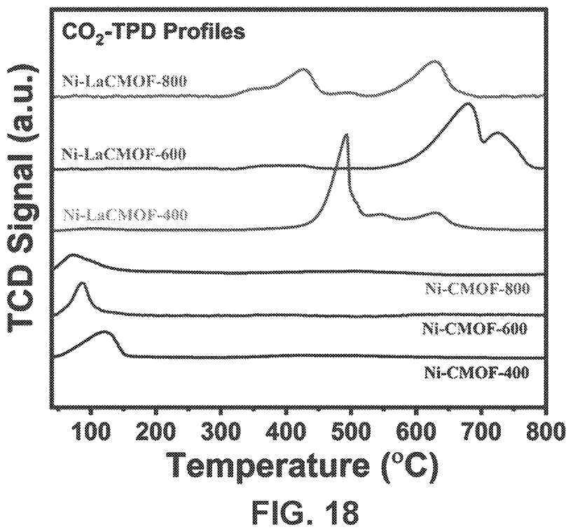

FIG. 18 illustrates CO₂-Temperature programmed desorption (TPD) profiles of Ni-BDC MOF and coalesced Ni-&La-BDC MOFs calcined at 400, 600, and 800° C., according to some embodiments. The pure Ni-based catalysts do not show any basicity as expected. All the CO₂ was adsorbed superficial and then released at low temperatures. However, the Ni—La MOF catalysts have shown very strong basic sites due to the presence of highly basic La₂O₃ support. This behavior of having strong basic sites in the catalysts can be beneficial in methane reforming and CO₂ reduction reactions as the catalysts can interact more with CO₂ and present higher catalytic activity. Also, this can lead to a new category of dual functional materials (adsorption and conversion of CO₂).

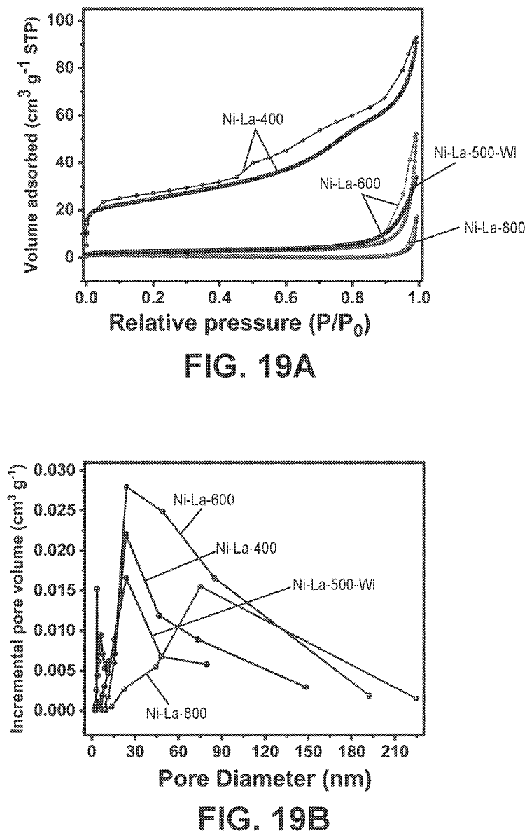

From FIG. 17A, it is evident that the N₂ adsorption-desorption isotherms and pore size (mesoporous behavior) distribution of both the catalysts behave similarly, except that the Ni—La-500 catalyst show high N₂ adsorption at high relative pressures. The BET surface area, pore volume, and average pore size values (given in Table 1) of as-synthesized Ni—La-500 catalyst are 13.6 m²/g, 0.1 cm³/g, and 29.6 nm and that of Ni—La-500 PM are 10.3 m²/g, 0.09 cm³/g, and 33 nm, respectively. On the other hand, FIG. 19A illustrates N₂ adsorption-desorption isotherms of Ni—La-400, Ni—La-600, Ni—La-800 and Ni—La-500-WI (wetness impregnation) catalysts, according to some embodiments. The Ni—La-400 catalyst shows different behavior. This is due to the existence of additional intact CO₂ molecules with the catalyst during the synthesis at 400° C. This prevails high surface area (87 m²/g, Table 1) and also observes the microporous nature. FIG. 19B illustrates pore size distribution profiles of Ni—La-400, Ni—La-600, Ni—La-800 and Ni—La-500-WI (wetness impregnation) catalysts, according to some embodiments. As the synthesis temperature increases, the surface area has been decreased due to sintering occurring at elevated temperatures, causing large size nanoparticles and minimizing the surface area.

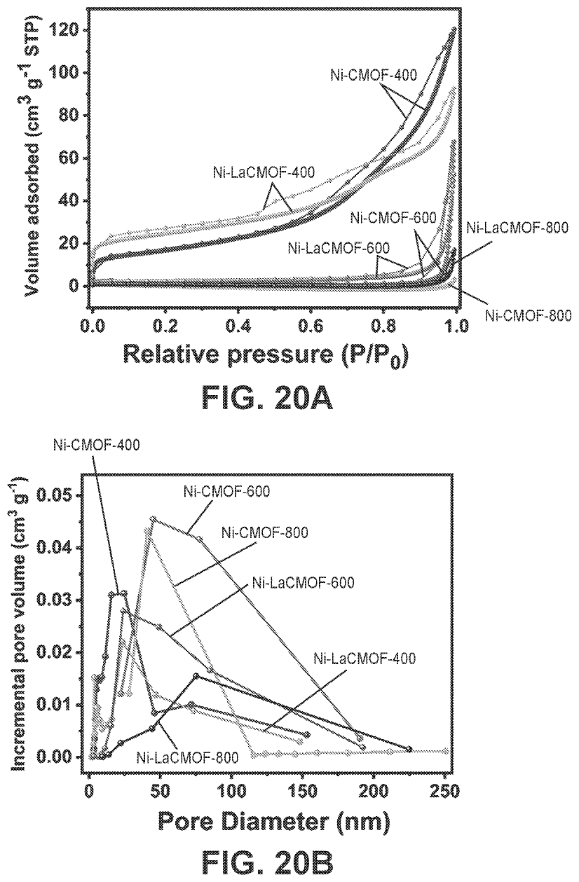

FIG. 20A illustrates N₂ adsorption-desorption hysteresis of Ni-BDC MOF and coalesced Ni-&La-BDC MOFs calcined at 400, 600, and 800° C., according to some embodiments. The catalysts that are calcined at 400° C. have shown high N₂-adsorption capability, followed by the 600° C. and then the 800° C. calcined catalysts. FIG. 20B illustrates the corresponding pore volume-size distribution profiles of Ni-BDC MOF and coalesced Ni-&La-BDC MOFs calcined at 400, 600, and 800° C., according to some embodiments. All the catalysts show the mesoporous nature with an average pore diameter varying from 5-40 nm (Table 1). The samples calcined at 600° C. have the highest pore volume as compared to other samples with moderate pore diameter. The surface area of the synthesized catalysts varies from 3-90 m²/g. Therefore, the surface and textural properties can be tuned with a wide range of surface area and porosity.

TABLE 1
Surface, textural, and chemisorption
properties of MOF derived catalysts.

| | | | | H₂ consumption |
|---|---|---|---|---|
| | SA_{BET} | PVₜₒₜₐₗ | Pore sizeₐᵥ | (mmol/g; |
| Catalyst | (m²/g) | (cm³/g) | (nm) | from H₂-TPR) |
| Ni—La-400 | 87 | 0.14 | 6 | 5.1 |
| Ni—La-500 | 13.6 | 0.10 | 29.6 | 5.1 |
| Ni—La-500 PM | 10.3 | 0.09 | 33 | 4.4 |
| Ni—La-600 | 9 | 0.08 | 36 | 3.5 |
| Ni—La-800 | 4 | 0.02 | 24 | 2.8 |
| Ni—La-500 WI | 8.9 | 0.05 | 23.4 | 5.6 |

PM = physical mixture;
WI = wetness impregnation

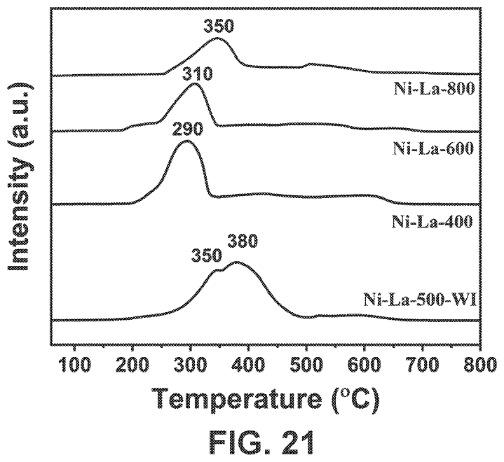

FIG. 21 illustrates H₂-TPR profiles of Ni—La-400, Ni—La-600, Ni—La-800, and Ni—La-500-WI catalysts, according to some embodiments. Similarly, the Ni—La-400 catalyst also exhibited an NiO reduction peak at 290° C. However, the same peak for Ni—La-500 PM is observed at even higher temperature (325° C.), due to the presence of bulk NiO particles, (evident from FIGS. 10B-10D) which requires high thermal energy to reduce. In a similar manner, the La₂O₂CO₃ decomposes early in the case of the Ni—La-500 catalyst (also due to the existence of La₂O₃ as minor phase) and required a high temperature in the case of the Ni—La-500-PM catalyst (due to the presence of more amount of La₂O₂CO₃ phase as seen from FIG. 10A). Similarly, the Ni—La-600, Ni—La-800, and Ni—La-500 WI catalysts have shown NiO reduction peaks above 300° C. due to the formation of bigger sized NiO nanoparticles observed in Ni—La-500 PM catalyst.

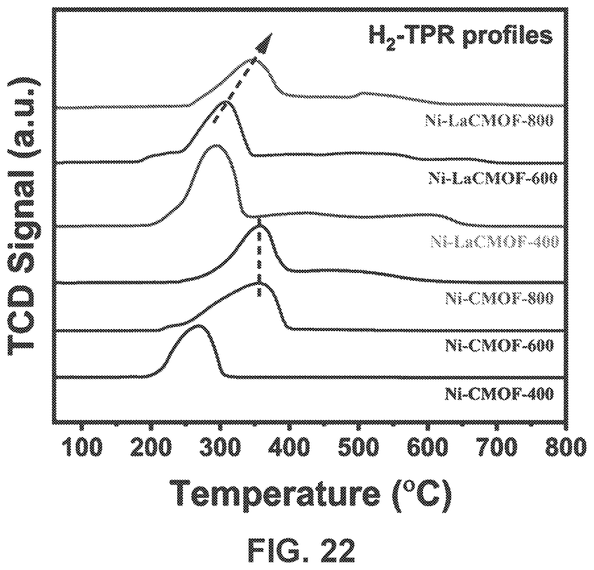

FIG. 22 illustrates H₂-temperature programmed reduction (TPR) profiles of Ni-BDC MOF and coalesced Ni-&La-BDC MOFs calcined at 400, 600, and 800° C. in 5% H₂ with a heating rate of 10° C./min, according to some embodiments. The pure Ni catalysts have shown a red-shift in the reduction temperature from Ni-MOF-400 catalyst to Ni-MOF-600 and Ni-MOF-800 catalysts. This is due to the increase in the particle size or sintering with increasing temperature during the synthesis of the catalyst. High temperatures are required to reduce the bigger sized particles. This is also due to the lack of the support in the catalyst which can prevent/minimize the sintering effect by having the metal dispersed on it. A similar kind of red-shift in the reduction temperatures is also observed in Ni—LaMOF catalysts. The shift is large in the case of the Ni—LaMOF-800 catalyst, compared to others. This is due to the observation of SMSI which requires high temperatures to reduce the supported catalysts. Also, a small hump is observed in the Ni—LaMOF-800 catalyst at around 500° C., which supports the presence of SMSI phenomena. The pure Ni catalysts have shown higher H₂ consumption than the supported catalysts due to the lower loading of Ni-phase in the supported catalysts.

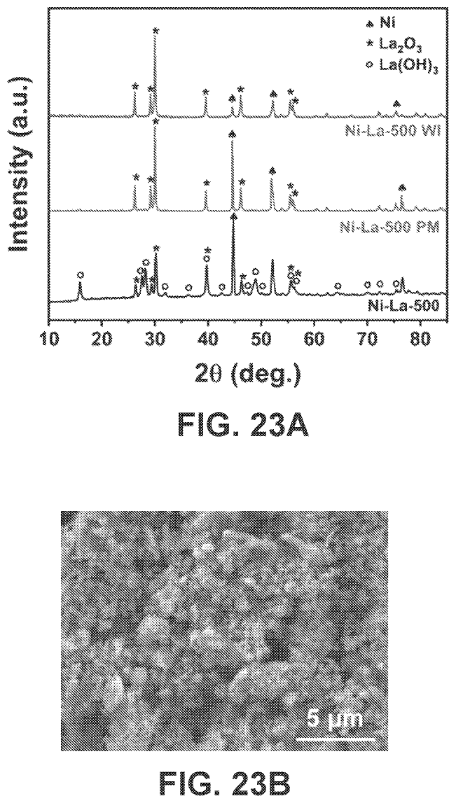

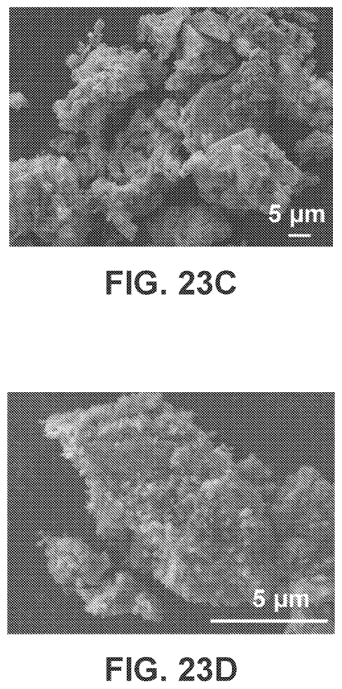

For a reducing analysis, the catalysts were reduced at 800° C. in 10% H₂ atmosphere. FIG. 23A illustrates XRD patterns of reduced Ni—La-500, Ni—La-500 PM, and Ni—La-500 WI catalysts, according to some embodiments. The support formed for Ni—La-500 includes La(OH)₃ with a minor La₂O₃ phase. Similarly, the Ni—La-400, Ni—La-600, and Ni—La-800 catalysts also included La(OH)₃ as a support after the reduction (FIG. 13F) and have shown almost similar morphology (FIGS. 14D-14F). FIG. 23B illustrates an SEM image of reduced Ni—La-500, according to some embodiments. FIG. 23C illustrates an SEM image of reduced Ni—La-500-PM, according to some embodiments. FIG. 23D illustrates an SEM image of reduced Ni—La-500-WI, according to some embodiments.

The SEM micrographs in FIGS. 23B-23D show that the Ni—La-500 catalyst has shown an even distribution of small particles on the support. However, both Ni—La-500-PM and Ni—La-500-WI catalysts form bulk phases. The Ni—La-500 PM and Ni—La-500 WI catalysts have La₂O₃ as a support material after reduction (FIG. 23A). The main difference is evident from the MOF derived catalysts. All the catalysts that were produced at different temperatures (400, 500, 600, and 800° C.) from the coalesced MOFs (via sonication process) formed La(OH)₃ as the supporting material after reduction. However, the physically mixed MOF derived catalyst (Ni—La-500 PM) exhibited La₂O₃ as support.

La₂O₂CO₃+5NiO+5H₂→2La(OH)₃₊₅Ni+2H₂O+CO₂(↑) (3)

La₂O₃+3NiO+3H₂→2La(OH)₃+3Ni (4)

The formation of different support materials highly depends upon the metal-support interactions that were formed during the synthesis of the catalysts. For the Ni—La-500 catalyst, the reduction of the La₂O₂CO₃ support happens simultaneously with the NiO nanoparticle reduction by following Equation 3. This is due to the SMSIs (evident from H₂-TPR, FIG. 17B) and good dispersion (FIGS. 8D-8F) of metal on the support. These conditions allow the spillover effect—the reduction of both metal and support occurs simultaneously.

The Ni—La-400 catalyst also follows Equation 3 during the reduction process. The Ni—La-600 and Ni—La-800 catalysts follow Equation 4 in which the La₂O₃ phase converts into La(OH)₃ in a hydrogen atmosphere at elevated temperature. However, for the Ni—La-500 PM catalyst, the reduction of NiO and La₂O₂CO₃ to Ni and La₂O₃ (reverse of Equation 1) is happening independently due to the formation of separate phases (evident from FIGS. 10B-10D) with weak interactions.

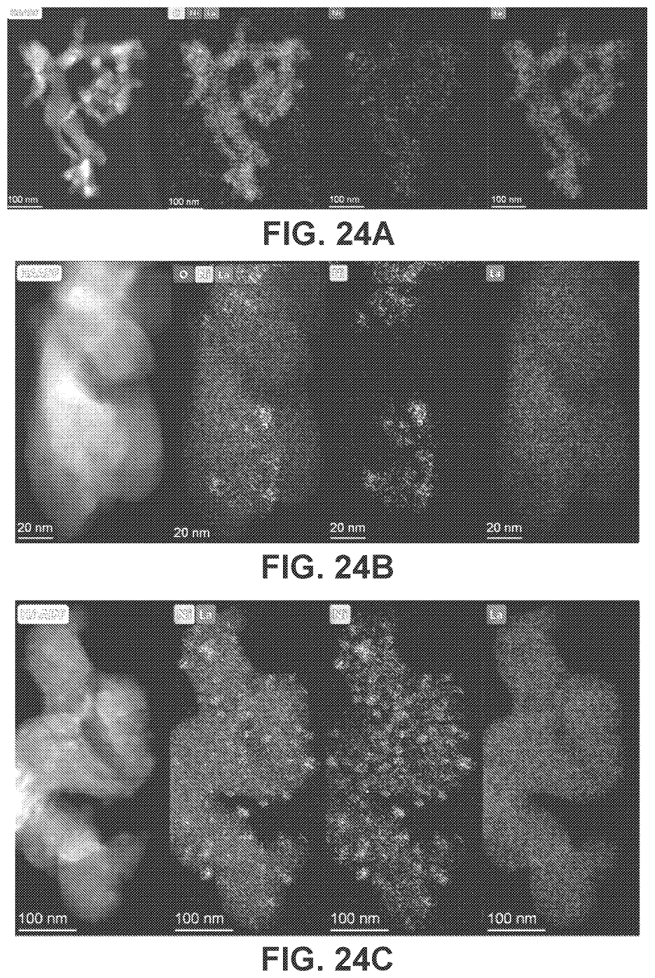

FIG. 24A illustrates TEM-HAADF analysis along with RGB elemental mapping of the Ni—La-500 reduced catalyst, according to some embodiments. FIG. 24B illustrates TEM-HAADF analysis along with RGB elemental mapping of the Ni—La-500 PM reduced catalyst, according to some embodiments. FIG. 24C illustrates TEM-HAADF analysis along with RGB elemental mapping of the Ni—La-500 WI reduced catalyst, according to some embodiments. Overall, the coalesced MOF derived catalysts exhibited a different reduction phenomenon compared to the physical mixture MOF derived catalyst. This suggests that the sonication method is establishing a strong interaction between the MOFs, which in turn affects the phase formations during the calcination and reduction processes. The metal-support interactions after the reduction are also visible from the TEM-HAADF analysis. The Ni—La-500 catalyst exhibited nanosized Ni nanoparticles highly dispersed on the support, implying SMSIs. However, the reduced Ni—La-500 PM and Ni—La-500 WI catalysts formed bigger sized Ni nanoparticles (due to the sintering happened at high temperatures) with poor dispersion, which indicates the lack of SMSIs.

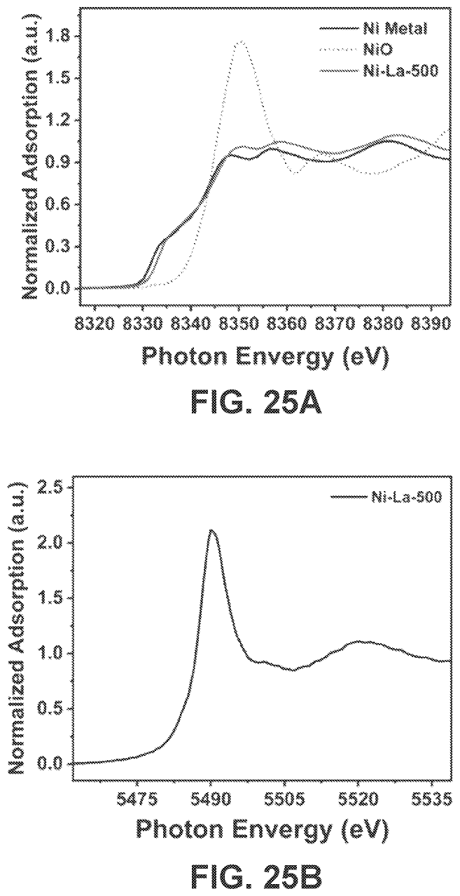

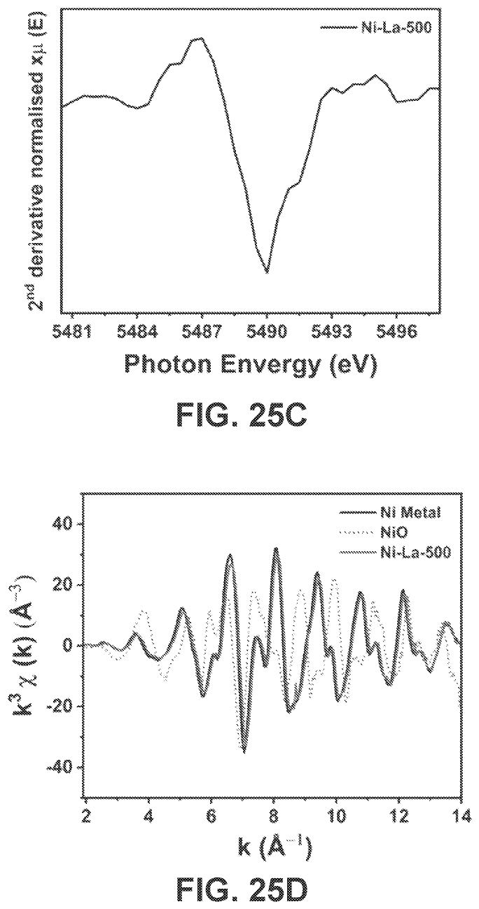

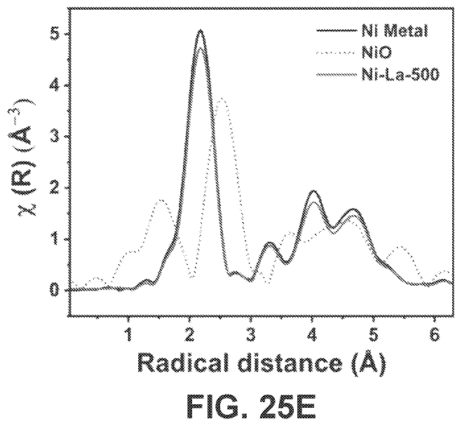

From the above analysis, the Ni—La-500 catalyst includes better metal dispersion along with SMSIs. FIG. 25A illustrates normalized XANES Ni K-edge spectra of reduced Ni—La-500 catalyst, according to some embodiments. The XANES and EXAFS spectra were collected after reducing the Ni—La-500 catalyst at 800° C. for 2 hours under H₂ atmosphere. The Ni Foil and NiO were employed for comparison. XANES of Ni—La-500 catalyst exhibit three local maxima at 8350 eV, 8359 eV, and 8383 eV akin to Ni metal (8348 eV, 8357 eV and 8381 eV), indicating that the Ni exists in the form of a metallic Ni⁰ state. However, the maxima were moved slightly toward higher energies compared to metallic Ni, which implies the existence of Ni+2 formed on the surface of the catalyst (this may be due to the partial oxidation of surface Ni during the interaction of the catalyst with open air atmosphere after the reduction). To determine the quantitative formation of metallic Ni and Ni+2 in the samples, the linear combination fitting of XANES of the samples were applied with Ni metal and NiO references.

FIG. 25B illustrates normalized XANES La L3-edge spectra of reduced Ni—La-500 catalyst, according to some embodiments. The La L3-edge XANES spectra exhibit one peak at around 5490 eV photon energy, which can be attributed to La 2p-5d electron transition. Usually, the 5d-splitting feature affect the peak intensity and full-width half maximum (FWHM) for La₂O₃, La₂O₂CO₃ and La(OH)₃, which can be distinguish by second derivative of XANES. FIG. 25C illustrates normalized XANES second derivative La L3-edge spectra of reduced Ni—La-500 catalyst, according to some embodiments. The strong appearance of one peak in La L3-edge second derivative XANES spectrum shows the presence of either La(OH)₃ and La₂O₂CO₃ phases, whereas the La₂O₃ phase exhibits a doublet. In the present case, this peak is attributed to the La(OH)₃ phase, which is confirmed from the XRD analysis (FIG. 23A).

FIG. 25D illustrates normalized K³-weighed EXAFS signals at the Ni K-edge of reduced Ni—La-500 catalyst (extended X-ray absorption fine structure) signals at the Ni K-edge, according to some embodiments. From EXAFS data, it is evident that the peak patterns and hence the local structure of Ni in the catalyst is analogous to pure Ni metal. To elucidate the local structure environment of Ni in Ni—La-500 catalyst, EXAFS data was also fitted using different theoretical models. FIG. 25E illustrates the corresponding Fourier transform with Ni Metal, NiO, and reduced Ni—La-500 catalyst, according to some embodiments. The Fourier transforms of EXAFS reveal two well-defined coordination shells at 2.48 Å and 1.97 Å, which are attributed to the Ni—Ni and Ni—O scattering contributions, respectively. The Ni—Ni contribution in the first shell observed at 2.48 Å (which is near to FCC Ni metal, 2.49 Å) exhibits a 6.9 coordination number, while that of Ni—O at 1.97 Å is 0.15. The observed lower coordination numbers in the Ni—La-500 catalyst suggest the formation of small sized Ni particles. In addition to the Ni—Ni and Ni—O shell, a significant Ni—La scattering was also observed, indicating SMSI between the Ni metal and lanthanum support.

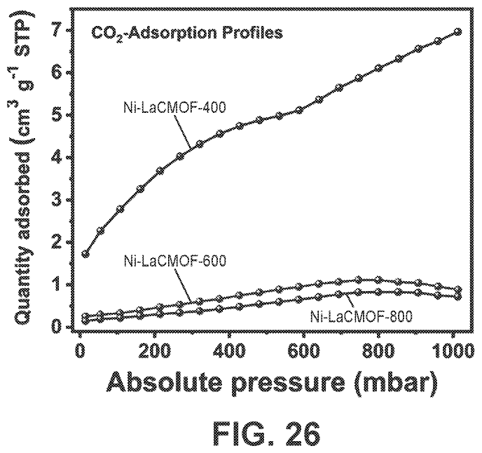

FIG. 26 illustrates CO₂-Adsorption profiles of coalesced Ni-&La-BDC MOFs calcined at 400, 600, and 800° C. at room temperature and up to 1 bar pressure, according to some embodiments. The Ni—LaMOF-400 catalyst has shown the highest amount of CO₂ adsorption compared to other catalysts. Although the CO₂ adsorption numbers shown in Table 2 are on lower side, the measurement infers that the prepared catalysts can be used for adsorption applications, and the capability can be tuned by designing different catalysts by choosing different metals or different organic ligands used for the MOF synthesis.

TABLE 2
Surface, texture, and chemisorption properties of as-synthesized catalysts.

| | | | | H₂ | | |
|---|---|---|---|---|---|---|
| | | | | consumption | | CO₂ adsorption |
| | | | Pore | (mmol/g; | CO₂ desorption | (cm³/g; at 25° C. and |
| | SA_{BET} | PVₜₒₜₐₗ | sizeₐᵥ | from | (mmol/g; from | 1 bar; from |
| Sample | (m²/g) | (cm³/g) | (nm) | H₂-TPR) | CO₂-TPD) | CO₂-Adsorption) |
| Ni-MOF-400 | 57 | 0.186 | 13 | 12.3 | 0.51 | — |
| Ni-MOF-600 | 9.5 | 0.1 | 5 | 11.7 | 0.07 | — |
| Ni-MOF-800 | 3.2 | 0.004 | 13 | 6.3 | 0.025 | — |
| Ni—La MOF-400 | 87 | 0.14 | 6 | 5.1 | 3.53 | 6.96 |
| Ni—La MOF-600 | 9 | 0.08 | 36 | 3.5 | 0.81 | 0.88 |
| Ni—La MOF-800 | 4 | 0.02 | 24 | 2.8 | 0.15 | 0.72 |

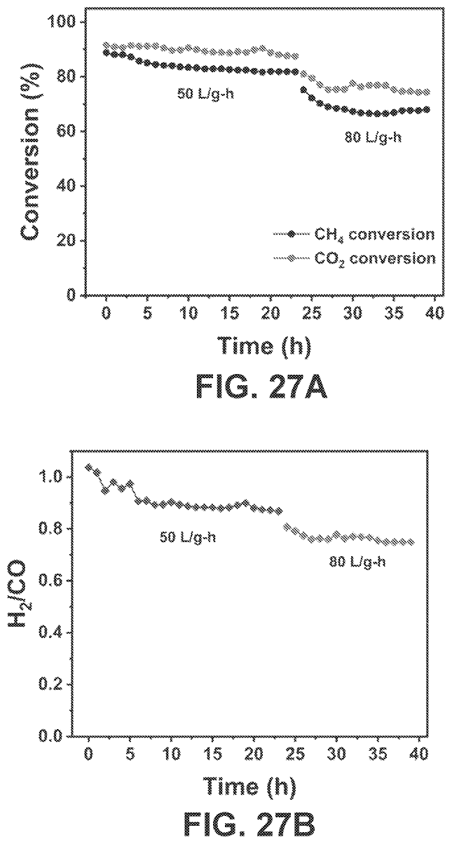

The catalytic activity for the MOF derived catalysts were tested for dry reforming of methane (DRM). All the catalysts were reduced in-situ at 800° C. prior to the DRM activity. FIG. 27A illustrates DRM activity of a MOF derived Ni—La-500 catalyst showing CH₄ and CO₂ conversion rates, according to some embodiments. This figure shows the CH₄ and CO₂ conversion rates of Ni—La-500 catalyst at 50 and 80 L·g_{cat}⁻¹·h⁻¹ GHSVs. Theoretically (according to the thermodynamic limit and Gibbs free-energy calculations), a maximum of 96% CH₄ conversions can be expected at 800° C. with the coke-resistant catalysts under low GHSVs (e.g.: <20 L·g_{cat}⁻¹·h⁻¹). The Ni—La-500 catalyst showed initial CH₄ conversion rates of 89 and 75% at 50 and 80 L·g_{cat}⁻¹·h⁻¹ GHSVs, respectively. FIG. 27B illustrates DRM activity of MOF derived Ni—La-500 catalyst showing H₂:CO product ratio, according to some embodiments.

The most remarkable observation in this catalyst is that even after increasing the GHSV by more than 1.5 times, to 80 L·g_{cat}⁻¹·h⁻¹, the CH₄ conversion rate is decreased by only a few percent, while exhibiting stable conversion rates. This observation suggests that the effect of external mass transfer is very minimal in these range of GHSVs.

CO₂+H₂↔CO+H₂O (5)

The H₂:CO product ratio at 80 L·g_{cat}⁻¹·h⁻¹ GHSV is slightly decreased compared to that of 50 L·g_{cat}⁻¹·h⁻¹ GHSV, suggesting that the ratio of RWGS (reverse water gas shift, equation 5) reaction to DRM is greater at higher GHSVs.

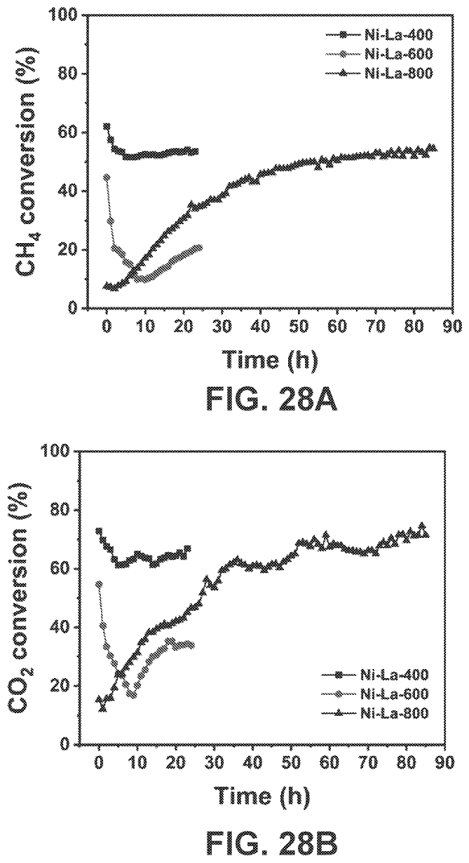

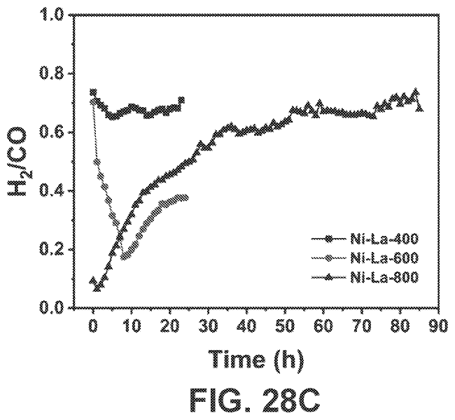

FIG. 28A illustrates a comparison of DRM activity of Ni—La-400, Ni—La-600, and Ni—La-800 catalysts based on CH₄ conversion, according to some embodiments. FIG. 28B illustrates a comparison of DRM activity of Ni—La-400, Ni—La-600, and Ni—La-800 catalysts based on CO₂ conversion, according to some embodiments. FIG. 28C illustrates a comparison of DRM activity of Ni—La-400, Ni—La-600, and Ni—La-800 catalysts based on H₂:CO product ratio, according to some embodiments. The DRM activity of Ni—La-400, Ni—La-600, and Ni—La-800 catalysts was done at 50 L·g_{cat}⁻¹·h⁻¹ GHSV. All three catalysts have shown different behavior in conversion rates. The Ni—La-400 catalyst has shown higher catalytic activity than others.

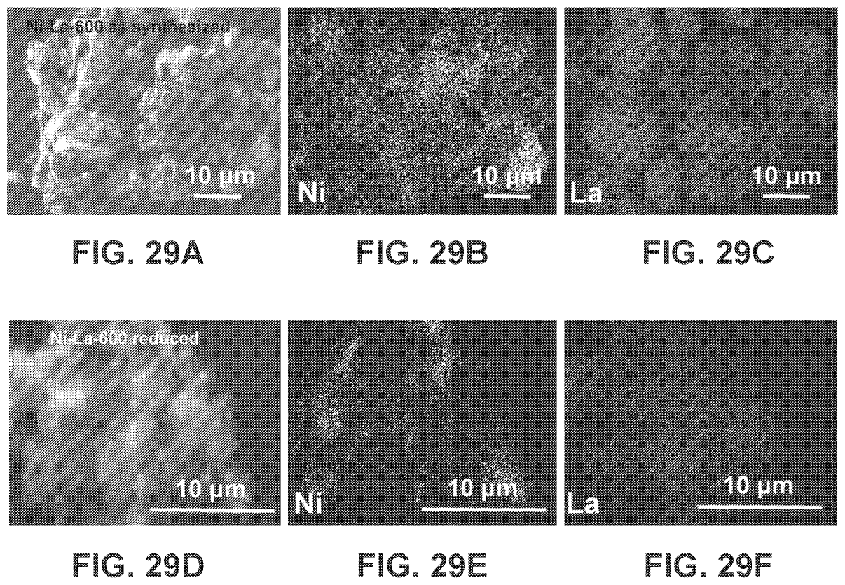

FIG. 29A illustrates an SEM image of as-synthesized Ni—La-600 catalyst, according to some embodiments. FIG. 29B illustrates elemental mapping of Ni in the Ni—La-600 catalyst, according to some embodiments. FIG. 29C illustrates elemental mapping of La in the Ni—La-600 catalyst, according to some embodiments. FIG. 29D illustrates an SEM image of a reduced Ni—La-600 catalyst, according to some embodiments. FIG. 29E illustrates elemental mapping of Ni in the reduced Ni—La-600 catalyst, according to some embodiments. FIG. 29F illustrates elemental mapping of La in the reduced Ni—La-600 catalyst, according to some embodiments.

The analysis suggests that the catalyst contains a larger sized Ni phase with poor dispersion on the support, which limits the available active metal sites for the DRM reaction-creating lower conversion rates. Although the Ni—La-800 catalyst has shown a steady increment in the conversion rates, the catalyst required almost 50 hours to attain maximum conversion rates. The slow activation and stable conversion rates of Ni—La-800 catalyst is attributed to the presence of both small and bigger sized Ni phase (FIGS. 16A-16H) along with SMSIs (unlike the Ni—La-600 catalyst), which is evident from the TEM analysis.

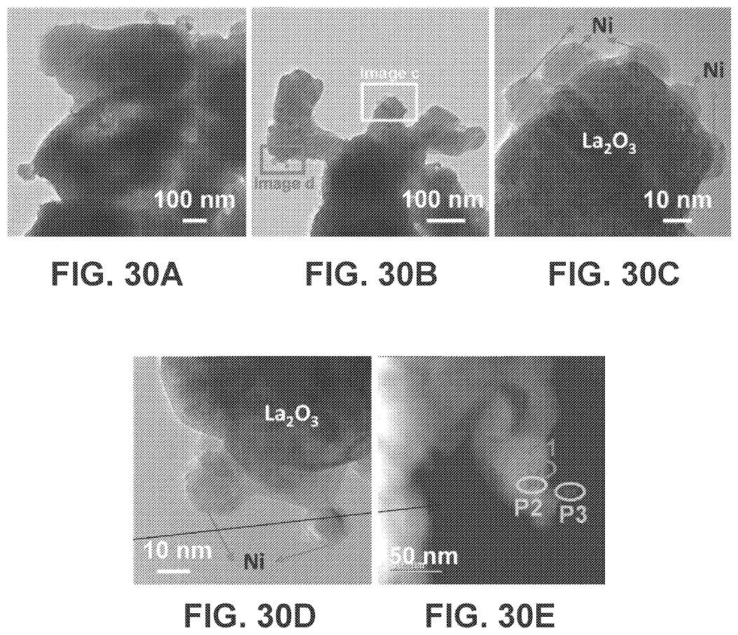

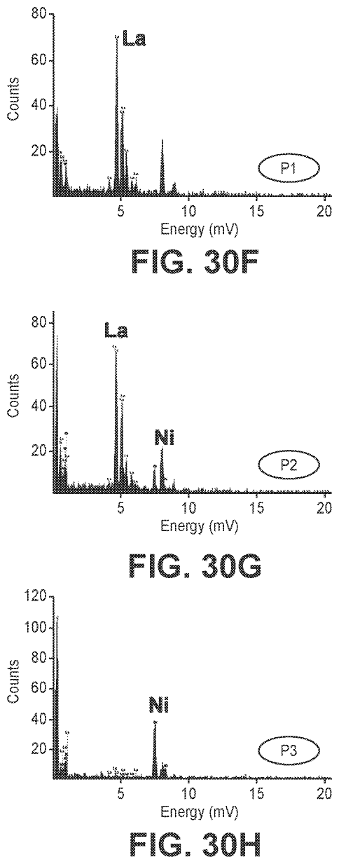

FIG. 30A illustrates TEM analysis of reduced Ni—La-800 catalyst, showing the distributed and exsolved Ni nanoparticles on La₂O₃ support, according to some embodiments. FIG. 30B illustrates TEM analysis of reduced Ni—La-800 catalyst, showing the distributed and exsolved Ni nanoparticles on La₂O₃ support, according to some embodiments. FIG. 30C illustrates TEM analysis of reduced Ni—La-800 catalyst, showing the strongly anchored 10-20 nm sized Ni nanoparticles on the support, according to some embodiments. FIG. 30D illustrates TEM analysis of reduced Ni—La-800 catalyst, showing the strongly anchored 10-20 nm sized Ni nanoparticles on the support, according to some embodiments. This proves the concept of SMSI which is vital for many catalytic applications (for species diffusion and electrons flow). For example, Ni-based catalysts used in dry reforming of methane reaction suffer from coking and sintering which limits their applicability in industries (this constitutes the main reason for why DRM not been industrialized yet). The SMSI helps in preventing these effects and improves the better usage of the catalysts metal and support area. The current synthesis approach has produced the catalysts with tunable SMSI.

FIG. 30E illustrates an STEM image of reduced Ni—La-800 catalyst used for the EDS analysis at three different points to see the distribution of Ni nanoparticles on La₂O₃ after reduction, according to some embodiments. FIG. 30F illustrates the corresponding EDS spectrum with P1 showing the pure La₂O₃ phase, according to some embodiments. FIG. 30G illustrates the corresponding EDS spectrum with P2 showing both Ni and La phases, according to some embodiments. FIG. 30H illustrates the corresponding EDS spectrum with P3 showing the pure Ni phase, according to some embodiments. P3 shows the pure Ni phase (also confirms the conversion of NiO phase to Ni phase during the reduction process) infers about the exsolved Ni nanoparticles anchored to the La₂O₃ support. Overall, the DRM activity of the coalesced MOF derived catalysts have shown stable conversion rates (except Ni—La-600 catalyst) with tunable SMSIs by varying the calcination temperatures during the synthesis of the catalysts.

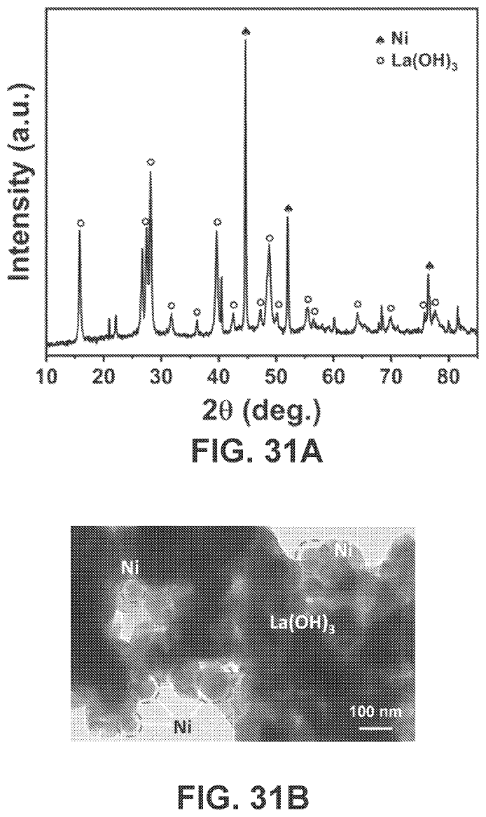

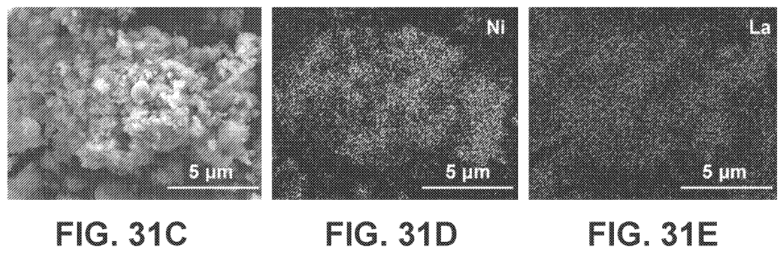

FIG. 31A illustrates an XRD pattern of Ni—La-500 after DRM reaction, according to some embodiments. FIG. 31A shows the XRD pattern of the spent catalyst consists of both Ni and La(OH)₃ phases with some additional phases. Interestingly, the La(OH)₃ support formed after the reduction (FIG. 23A) remains the same even after the DRM activity. The presence of both H₂ (produced during DRM activity) and the H₂O molecules (formed due to RWGS reaction, Equation 5) may help to retain the La(OH)₃ phase, which otherwise should have ended up as an La₂O₃ phase via the reverse reaction of Equation 2.

FIG. 31B illustrates a low-magnification TEM image of Ni—La-500 after DRM reaction, according to some embodiments. The low-magnification TEM image shows that the Ni nanoparticles are well socketed into the support with SMSIs and there are no signs of carbon formation. Little graphitic carbon was found to be formed around Ni nanoparticles. On the other hand, the size of the Ni nanoparticles after the DRM activity was estimated to be in the range of 30-80 nm, suggesting that a slight sintering happened during the DRM activity at elevated temperatures.

FIG. 31C illustrates an SEM image of Ni—La-500 catalyst after DRM reaction, according to some embodiments. FIG. 31D illustrates elemental mapping of Ni for Ni—La-500 catalyst after DRM reaction, according to some embodiments. FIG. 31E illustrates elemental mapping of La for Ni—La-500 catalyst after DRM reaction, according to some embodiments. The SEM image and elemental mapping suggest that the Ni nanoparticles are well dispersed on the support. The existence of SMSIs and good dispersion of the Ni nanoparticles on the support minimized the two major issues (sintering and coking) faced by most of the Ni-based catalysts. The MOF derived catalyst (Ni—La-500) has successfully mitigated these two challenges of Ni-based catalysts to a large extent without compromising the catalytic activity, by exhibiting high and stable conversion rates.

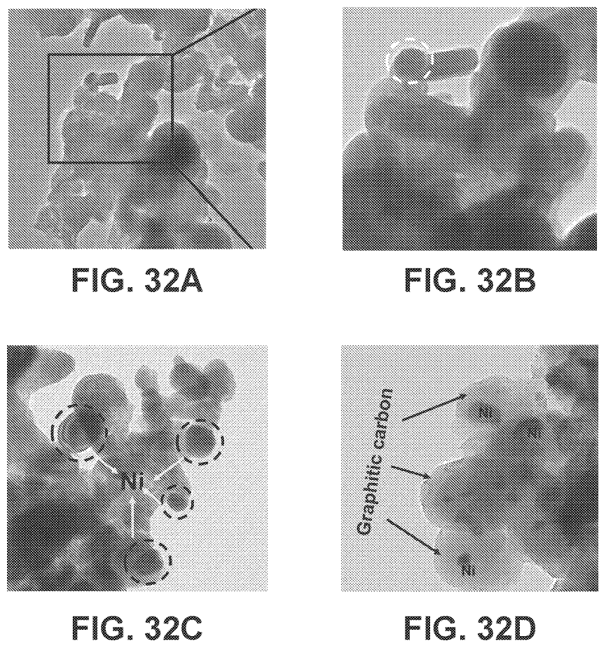

FIG. 32A illustrates a TEM image of Ni—La-500 catalyst after DRM, showing no signs of carbon formation, according to some embodiments. FIG. 32B illustrates a TEM image of Ni—La-500 catalyst after DRM, showing Ni nanoparticles embedded in the support with strong SMSI, according to some embodiments. FIG. 32C illustrates a TEM image of Ni—La-500 catalyst after DRM, showing Ni nanoparticles embedded in the support with strong SMSI, according to some embodiments. FIG. 32D illustrates a TEM image showing very slight carbon formed in the form of graphitic carbon surrounding the Ni nanoparticles, according to some embodiments.

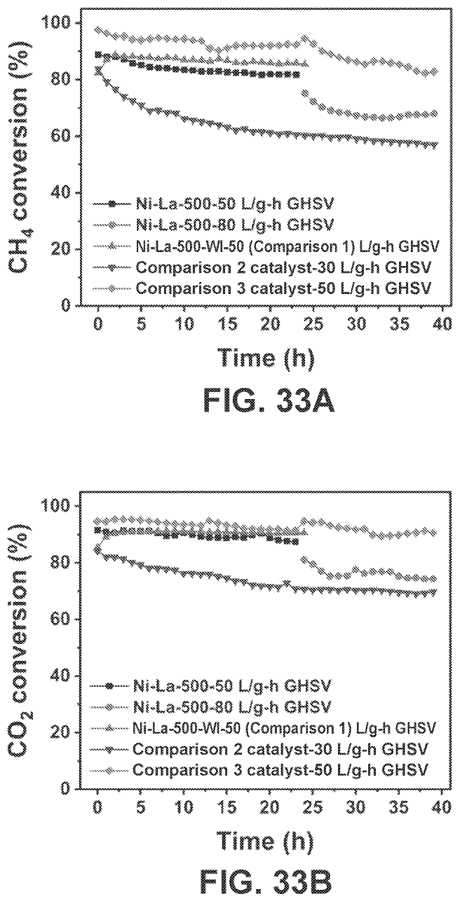

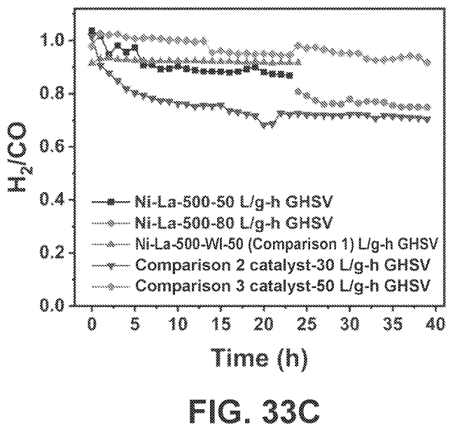

Further, the Ni—La-500 MOF derived catalyst was compared with comparison 1 catalyst Ni—La-500 WI (wetness impregnation), comparison 2 catalyst (5 wt % Ni/CeLa-10Cu—O), and comparison 3 catalyst (used for industrial steam reforming of methane). FIG. 33A illustrates a comparison of DRM activity for CH₄ conversion with a Ni—La-500 catalyst with comparison 1 catalyst Ni—La-500-WI (wetness impregnation), comparison 2 catalyst (5 wt % Ni/CeLa-10Cu—O) and comparison 3 catalyst (used for industrial steam reforming of methane), according to some embodiments. FIG. 33B illustrates a comparison of DRM activity for CO₂ conversion with a Ni—La-500 catalyst with comparison 1 catalyst Ni—La-500-WI (wetness impregnation), comparison 2 catalyst (5 wt % Ni/CeLa-10Cu—O) and comparison 3 catalyst (used for industrial steam reforming of methane), according to some embodiments. FIG. 33C illustrates a comparison of DRM activity for H₂:CO product ratio of Ni—La-500 catalyst with comparison 1 catalyst Ni—La-500-WI (wetness impregnation), comparison 2 catalyst (5 wt % Ni/CeLa-10Cu—O) and comparison 3 catalyst (used for industrial steam reforming of methane), according to some embodiments.

Among all the catalysts, the comparison 3 catalyst has shown continuous decrement in conversion rates at 50 L·g_{cat}⁻¹·h⁻¹ GHSV. This industrial steam reforming of methane catalyst lacks the stable catalytic activity even with high conversion rates at the initial hours. Similarly, the (5 wt % Ni/CeLa-10Cu—O) catalyst has shown the same behavior as that of comparison 3 catalyst, even at lower GHSV (30 L·g_{cat}⁻¹·h⁻¹).

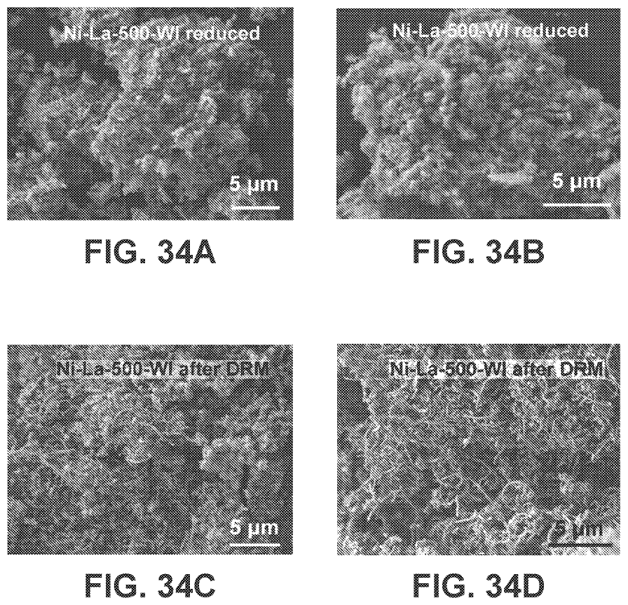

FIG. 34A illustrates an SEM image (before DRM activity or reduced) of Ni—La-500-WI, according to some embodiments. FIG. 34B illustrates an SEM image (before DRM activity or reduced) of Ni—La-500-WI, according to some embodiments. FIG. 34C illustrates an SEM image (after DRM) of Ni—La-500-WI, according to some embodiments. FIG. 34D illustrates an SEM image (after DRM) of Ni—La-500-WI, according to some embodiments. The Ni—La-500 WI catalyst ended up with significant coking, even at lower GHSV (50 L·g_{cat}⁻¹·h⁻¹) for 24 hours of DRM activity. In conclusion, the MOF derived catalyst (Ni—La-500) has shown stable conversion rates and coke-resistance towards DRM activity, compared to all other catalysts.

### Discussion of Possible Embodiments

According to one aspect, a catalyst includes a lanthanum support including one or more of lanthanum oxycarbonate, lanthanum oxide, and lanthanum hydroxide, and nanoparticles including one or more of a transition metal and a transition metal oxide, wherein the nanoparticles are in contact with the lanthanum support sufficient for strong metal-support interaction (SMSI) and the nanoparticles are lanthanide-free and actinide-free.

The catalyst of the preceding paragraph can optionally include, additionally and/or alternatively any one or more of the following features, configurations and/or additional components.

The nanoparticles may be impregnated within pores of the lanthanum support.

The nanoparticles may be attached to an outer surface of the lanthanum support.

The diameter of the nanoparticles may range from 5 nm to 25 nm.

The catalyst may be free of any MOF coordination and the lanthanum support may include one or more stacking faults.

The catalyst may include a product of sonicating and calcining a first metal organic framework (MOF) and a second MOF.

The first MOF may include a transition metal and the second MOF may include lanthanum.

The first MOF and the second MOF may include one or more organic ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

According to one aspect, a catalyst includes a product of sonicating and calcining a first metal organic framework (MOF) and a second MOF, wherein the catalyst includes a first phase including a metal-based support and a second phase including metal nanoparticles, and wherein the metal nanoparticles are embedded on and interact with the metal-based support sufficient for strong metal-support interactions (SMSI).

The catalyst of the preceding paragraph can optionally include, additionally and/or alternatively any one or more of the following features, configurations and/or additional components.

The first MOF and the second MOF may include transition metals.

The first MOF may include nickel and the second MOF may include lanthanum.

The first MOF and the second MOF may include one or more organic ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

The catalyst may be free of MOF coordination.

The metal nanoparticles may include one or more of nickel and nickel oxide.

The metal-based support may include one or more of lanthanum, cerium, silicon, zirconium, and aluminum.

The metal-based support may include one or more of lanthanum oxide, lanthanum hydroxide, lanthanum carbide, and lanthanum oxycarbonate.

The metal-based support may include two or more of lanthanum oxycarbonate, lanthanum oxide, and lanthanum hydroxide.

The metal-based support may include lanthanum oxycarbonate, lanthanum oxide, and lanthanum hydroxide.

According to one aspect, a method of processing a feed stock includes contacting the feed stock with a catalyst, sufficient to generate a reaction product. The catalyst includes a lanthanum support including one or more of lanthanum oxycarbonate, lanthanum oxide, and lanthanum hydroxide, and nanoparticles including one or more of a transition metal and a transition metal oxide, wherein the nanoparticles are in contact with the lanthanum support sufficient for strong metal-support interaction (SMSI) and are lanthanide and actinide-free.

The method of the preceding paragraph can optionally include, additionally and/or alternatively any one or more of the following features, configurations and/or additional components.

The feed stock may include one or more of carbon dioxide, methane, hydrogen, nitrogen, and water steam, and the reaction product may include one or more of hydrogen, carbon monoxide, methanol, methane, dimethyl ether, and ammonia.

The reaction may be selected from dry reforming of methane, stream reforming of methane, carbon dioxide reduction reaction, and nitrogen reduction reaction.

The catalyst may include a MOF derived catalyst formed from sonicating two or more MOF precursors.

The MOF precursors may include one or more metals selected from nickel and lanthanum and include one or more organic ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

According to one aspect, a method of making a catalyst includes providing a first solution including sonication of a first metal organic framework (MOF), providing a second solution including sonication of a second MOF, and contacting the sonicated first solution and the sonicated second solution sufficient to form a third solution. The method of making the catalyst further includes sonicating the third solution sufficient to interact the first MOF with the second MOF and form a coalesced MOF, separating and drying the coalesced MOF, and heating the coalesced MOF at a temperature setpoint sufficient to obtain the catalyst.

The method of the preceding paragraph can optionally include, additionally and/or alternatively any one or more of the following features, configurations and/or additional components.

The first MOF may include nickel and the second MOF may include lanthanum.

The first MOF and the second MOF may include one or more ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

The temperature setpoint may include a temperature ranging from 200° C. to 1000° C. and the coalesced MOF is heated at a rate ranging from 2° C./min to 20° C./min.

The coalesced MOF may be heated in the presence of one or more of an inert gas, air, ammonia, and hydrogen sulfide.

The catalyst may include a support selected from lanthanum oxide, lanthanum hydroxide, and lanthanum oxycarbonate.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

1. A catalyst, the catalyst comprising:
a lanthanum support including one or more of lanthanum oxycarbonate, lanthanum oxide, and lanthanum hydroxide; and
nanoparticles including one or more of a transition metal and a transition metal oxide,
wherein the nanoparticles are in contact with the lanthanum support sufficient for strong metal-support interaction (SMSI) and the nanoparticles are lanthanide-free and actinide-free.

2. The catalyst according to claim 1, wherein the nanoparticles are impregnated within pores of the lanthanum support.

3. The catalyst according to claim 1, wherein the nanoparticles are attached to an outer surface of the lanthanum support.

4. The catalyst according to claim 1, wherein the nanoparticles include one or more of nickel and nickel oxide.

5. The catalyst according to claim 1, wherein a diameter of the nanoparticles ranges from 5 nm to 25 nm.

6. The catalyst according to claim 1, wherein the catalyst is free of any MOF coordination and the lanthanum support includes one or more stacking faults.

7. The catalyst according to claim 1, wherein the catalyst includes a product of sonicating and calcining a first metal organic framework (MOF) and a second MOF.

8. The catalyst according to claim 7, wherein the first MOF includes a transition metal and the second MOF includes lanthanum.

9. The catalyst according to claim 7, wherein the first MOF and the second MOF include one or more organic ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

10. A method of processing a feed stock, the method comprising:
contacting the feed stock with a catalyst, sufficient to generate a reaction product, wherein the catalyst includes:
a lanthanum support including one or more of lanthanum oxycarbonate, lanthanum oxide, and lanthanum hydroxide; and
nanoparticles including one or more of a transition metal and a transition metal oxide,
wherein the nanoparticles are in contact with the lanthanum support sufficient for strong metal-support interaction (SMSI) and are lanthanide and actinide-free.

11. The method according to claim 10, wherein the feed stock includes one or more of carbon dioxide, methane, hydrogen, nitrogen, and water steam, and wherein the reaction product includes one or more of hydrogen, carbon monoxide, methanol, methane, dimethyl ether, and ammonia.

12. The method according to claim 10, including a reaction selected from dry reforming of methane, stream reforming of methane, carbon dioxide reduction reaction, and nitrogen reduction reaction.

13. The method according to claim 10, wherein the catalyst includes a MOF derived catalyst formed from sonicating two or more MOF precursors.

14. The method according to claim 13, wherein the MOF precursors include one or more metals selected from nickel and lanthanum and include one or more organic ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

15. A method of making a catalyst, the method comprising:
providing a first solution including sonication of a first metal organic framework (MOF);
providing a second solution including sonication of a second MOF;
contacting the sonicated first solution and the sonicated second solution sufficient to form a third solution;
sonicating the third solution sufficient to interact the first MOF with the second MOF and form a coalesced MOF;
separating and drying the coalesced MOF; and
heating the coalesced MOF at a temperature setpoint sufficient to obtain the catalyst.

16. The method according to claim 15, wherein the first MOF includes nickel, and the second MOF includes lanthanum.

17. The method according to claim 15, wherein the first MOF and the second MOF include one or more ligands selected from BDC (benzenedicarboxylic acid), BTB (1,3,5-tris(4-carboxyphenyl)-benzene), BTC (benzene tricarboxylate), BPDC (2,2′-dimethylbiphenyl-4,4′-dicarboxylate), PBA (phenylboronic acid), BPY (2,2′-bipyridine).

18. The method according to claim 15, wherein the temperature setpoint includes a temperature ranging from 200° C. to 1000° C. and the coalesced MOF is heated at a rate ranging from 2° C./min to 20° C./min.

19. The method according to claim 15, wherein the coalesced MOF is heated in the presence of one or more of an inert gas, air, ammonia, and hydrogen sulfide.

20. The method according to claim 15, wherein the catalyst includes a support selected from lanthanum oxide, lanthanum hydroxide, and lanthanum oxycarbonate.
